(19) United States
(12) Patent Application Publication
(10) Pub. No.: US 2021/0278834 A1
(43) Pub. Date: Sep. 9, 2021

(54) Method for Exploration and Mapping Using an Aerial Vehicle

(71) Applicant: Emesent IP Pty Ltd., Pullenvale, Queensland (AU)

(72) Inventors: Farid Kendoul, Pullenvale, Queensland (AU); Stefan Hrabar, Pullenvale, Queensland (AU)

(73) Assignee: Emesent IP Pty Ltd., Pullenvale, Queensland (AU)

(21) Appl. No.: 17/260,781

(22) PCT Filed: Jul. 17, 2019
(86) PCT No.: PCT/AU2019/050747

§ 371 Date: Jan. 15, 2021

(30) Foreign Application Priority Data
Jul. 17, 2018 (AU) 2018902588

(51) Int. Cl. G05D 1/00; G06K 9/00; G08G 5/00; G05D 1/10; B64C 39/02

(52) U.S. Cl. CPC G05D 1/0027; G06K 9/0063; G05D 1/0016; G05D 1/0022; B64C 2201/141; G05D 1/1064; B64C 39/024; B64C 2201/123; G08G 5/0034

(57) ABSTRACT

A method for use in performing exploration and mapping of an environment, the method being performed using an aerial vehicle and a user processing system that wirelessly communicates with the aerial vehicle when the aerial vehicle is within communication range thereof, the method including: the aerial vehicle generating range data using a range sensor; whilst the aerial vehicle is within communication range, the aerial vehicle transmitting, to the user processing system, map data based on the range data; the user processing system displaying a map representation based on the map data; the user processing system obtaining user defined flight instructions; whilst the aerial vehicle is within communication range, the user processing system transmitting, to the aerial vehicle, flight instructions data based on the user defined flight instructions; and the aerial vehicle flying autonomously in accordance with the flight instructions data and the range data.

### BACKGROUND OF THE INVENTION

The present invention relates to a method for use in performing exploration and mapping using an aerial vehicle, and in particular a method for use in performing exploration and mapping of unknown GPS-denied environments, such as indoors and underground, using an unmanned or unpiloted aerial vehicle, beyond visual line of sight and/or beyond communication range.

### DESCRIPTION OF THE PRIOR ART

Unmanned aerial vehicles, often referred to as drones, are being used and adopted for industrial applications at an increasing rate and there is need and demand for more automation to increase the safety and efficiency of data collection. Furthermore, there is demand for additional functionality beyond standard cameras and images. For example, three dimensional Lidar (Light Detection and Ranging) data can be used to provide mapping functionality, which can benefit many industrial applications.

Whilst some systems have been described that use Lidar for SLAM (Simultaneous Localisation and Mapping), all of these are “passive” in the sense that they just collect data and use this for subsequent mapping, with drone guidance and flying being controlled by existing drone autopilots. Most Lidar systems utilise GPS and high-grade IMUs and as a result the systems tend to be expensive and are only able to operate in environments where GPS is available, meaning these cannot be used in GPS-denied environments such as indoors and underground, or GPS degraded environments, such as built-up areas, under bridges, or within tunnels, or the like.

In some applications and scenarios drones might be required to collect data (mapping, inspection, images, gas, radiations, etc.) from areas that are inaccessible to humans (dangerous or not possible) such as in underground mining stopes, underground urban utility tunnels, collapsed tunnels and indoor structures, etc. In these GPS-denied environments, generally there is no navigation map that the drone can use to navigate and the options are either, assisted flight in line of sight, or waypoint navigation where waypoints are selected by the operator during flight, or autonomous exploration.

However, these options each have associated downsides which have impeded wide scale adoption of drone technology in GPS-denied environments. Assisted flight is only possible in line of sight, or beyond visual line of sight (BVLOS) with first-person view (FPV) remote control but in communication range. Existing waypoint navigation methods have only dealt with the case where there is a communication link between the drone and the operator. Autonomous exploration is a useful functionality for many applications but it might not be suitable for applications where operator interaction is needed to guide the drone to very specific locations based on streamed data and mission objectives. Furthermore, autonomous exploration algorithms are not mature yet especially in complex environments such as the indoor and underground ones. Also, the user may be hesitant to use this functionality due to the lack of control or insight of what the drone might be doing during the exploration phase.

The reference in this specification to any prior publication (or information derived from it), or to any matter which is known, is not, and should not be taken as an acknowledgment or admission or any form of suggestion that the prior publication (or information derived from it) or known matter forms part of the common general knowledge in the field of endeavour to which this specification relates.

### SUMMARY OF THE PRESENT INVENTION

In one broad form an aspect of the present invention seeks to provide a method for use in performing exploration and mapping of an environment, the method being performed using an aerial vehicle and a user processing system that wirelessly communicates with the aerial vehicle when the aerial vehicle is within communication range of the user processing system, the method including: the aerial vehicle generating range data using a range sensor, the range data being indicative of a range to the environment; whilst the aerial vehicle is within communication range of the user processing system, the aerial vehicle transmitting, to the user processing system, map data based on the range data; the user processing system displaying, using a graphical user interface, a map representation based on the map data; the user processing system obtaining user defined flight instructions in accordance with user interactions with the graphical user interface; whilst the aerial vehicle is within communication range of the user processing system, the user processing system transmitting, to the aerial vehicle, flight instructions data based on the user defined flight instructions; and the aerial vehicle flying autonomously in accordance with the flight instructions data and the range data.

In one embodiment the method includes generating a map of the environment based on the range data.

In one embodiment the method includes, in one or more vehicle processing devices of the aerial vehicle, determining a flight plan based on the flight instructions data, the aerial vehicle flying autonomously in accordance with the flight plan.

In one embodiment the method includes, in the one or more vehicle processing devices: using the range data to generate pose data indicative of a position and orientation of the aerial vehicle relative to the environment; using the pose data and the flight instructions data to identify manoeuvres that can be used to execute the flight plan; generating control instructions in accordance with the manoeuvres; and transferring the control instructions to a vehicle control system of the aerial vehicle to cause the aerial vehicle to implement the manoeuvres and thereby fly autonomously in accordance with the flight plan.

In one embodiment the method includes, in the one or more vehicle processing devices: using the range data and pose data to generate a depth map indicative of a minimum range to the environment in a plurality of directions; and identifying the manoeuvres in accordance with the depth map to thereby perform collision avoidance.

In one embodiment the method includes, in the one or more processing devices: using the range data and pose data to generate an occupancy grid indicative of the presence of the environment in different voxels of the grid; and identifying the manoeuvres using the occupancy grid.

In one embodiment the method includes, while the aerial vehicle is flying autonomously, the aerial vehicle performing collision avoidance in accordance with the range data and at least one of: an extent to the aerial vehicle; and an exclusion volume surrounding an extent of the aerial vehicle.

In one embodiment the user defined flight instructions include one or more user defined waypoints obtained in accordance with user interactions with the graphical user interface.

In one embodiment the method includes the user processing system generating the flight instructions data based on the one or more user defined waypoints and the map data.

In one embodiment the method includes, for each user defined waypoint, the user processing system determining whether the user defined waypoint is separated from the environment by a predefined separation distance.

In one embodiment the method includes, in the event of a determination that the user defined waypoint is separated from the environment by the predefined separation distance, the user processing system generating the flight instructions data using the user defined waypoint.

In one embodiment the method includes, in the event of a determination that the user defined waypoint is not separated from the environment by the predefined separation distance, the user processing system modifying the user defined waypoint and generating the flight instructions data using the resulting modified user defined waypoint.

In one embodiment the method includes the user processing system modifying the user defined waypoint by shifting the user defined waypoint to a nearby point that is separated from the environment at least one of: by a predefined separation distance; and in accordance with defined constraints.

In one embodiment the user defined flight instructions include a predefined flight path segment selected in accordance with user interactions with the graphical user interface.

In one embodiment the user defined flight instructions include a predefined flight plan selected in accordance with user interactions with the graphical user interface.

In one embodiment the method includes the user processing system: generating a preview flight path based on the user defined flight instructions and the map data; and displaying, using the graphical user interface, the preview flight path in the map representation, for approval by the user.

In one embodiment the method includes the user processing system generating the preview flight path by determining flight path segments between waypoints of the user defined flight instructions.

In one embodiment the method includes the user processing system determining each flight path segment so that the flight path segment is separated from the environment by a predefined separation distance.

In one embodiment the method includes the user processing system: obtaining user approval of the preview flight path in accordance with user interactions with the graphical user interface; and in response to the user approval, transmitting the flight instructions data to the aerial vehicle.

In one embodiment the method includes the user processing system: obtaining a user modification input in accordance with user interactions with the graphical user interface, for identifying a desired modification to the user defined flight instructions; and modifying the user defined flight instructions in response to the user modification input.

In one embodiment the user defined flight instructions include waypoints and the method includes modifying the user defined flight instructions by at least one of: removing one of the waypoints; moving one of the waypoints; and adding a new waypoint.

In one embodiment the method includes, whilst the aerial vehicle is flying autonomously: the aerial vehicle continuing to generate range data; and whilst the aerial vehicle is within communication range of the user processing system, the aerial vehicle transmitting, to the user processing system, further map data generated based on the range data.

In one embodiment the further map data includes one of: any updates to the map data; updates to the map data in a predetermined time window; updates to the map data within a predetermined range of the aerial vehicle; and updates to the map data within a predetermined range of waypoints.

In one embodiment the method includes the aerial vehicle, upon completion of autonomous flight in accordance with the flight instructions data, determining whether the aerial vehicle is within communication range of the user processing system at a final position.

In one embodiment the method includes, in the event of a determination that the aerial vehicle is within communication range, the aerial vehicle hovering at the final position to await transmission of further flight instructions data from the user processing system.

In one embodiment the method includes, in the event of a determination that the aerial vehicle is not within communication range, the aerial vehicle autonomously flying to a communications position that is within communication range and hovering at the communications position to await transmission of further flight instructions data from the user processing system.

In one embodiment the method includes, in one or more vehicle processing devices of the aerial vehicle, determining a return flight plan based on the communications position and the range data, the aerial vehicle flying autonomously to the communications position in accordance with the return flight plan.

In one embodiment the method includes, whilst the aerial vehicle is flying autonomously, in the one or more vehicle processing devices: determining whether the aerial vehicle is within communication range of the user processing system; and storing at least an indication of a previous location that was within communication range.

In one embodiment the flight instructions data includes waypoints and the method includes the aerial vehicle storing an indication of whether each waypoint is within communication range after flying autonomously through each waypoint.

In one embodiment the map data includes at least one of: at least some of the range data; a three dimensional map generated based on the range data; an occupancy grid indicative of the presence of the environment in different voxels of the grid; a depth map indicative of a minimum range to the environment in a plurality of directions; and a point cloud indicative of points in the environment detected by the range sensor.

In one embodiment the map data is at least one of: generated as a down-sampled version of a map generated by the aerial vehicle using the range data; generated using simplified representations of known types of structures determined using the range data; and generated based on a subset of the range data.

In one embodiment the map representation includes at least one of: a two dimensional representation of the environment generated using the map data; and colour coded points where a colour of each point is selected to indicate at least one of: a position of the point in at least one dimension; and a distance of the point relative to the aerial vehicle in at least one dimension.

In one embodiment the method includes the user processing system dynamically updating the map representation in response to user manipulations of the map representation in accordance with user interactions with the graphical user interface.

In one embodiment the method includes: the aerial vehicle transmitting, to the user processing system, pose data together with the map data; and the user processing system displaying a vehicle representation in the map representation based on the pose data.

In one embodiment the method includes: the aerial vehicle transmitting, to the user processing system, flight plan data indicative of a flight plan determined by the aerial vehicle; and the user processing system displaying a representation of the flight plan in the map representation, based on the flight plan data.

In one embodiment the method includes: the user processing system obtaining at least one user selected heading in accordance with user interactions with the graphical user interface; and the user processing system generating the flight instructions data in accordance with the user selected heading.

In one embodiment the method includes: the user processing system determining flight parameters with regard to the user defined flight instructions; and the user processing system generating the flight instructions data in accordance with the flight parameters.

In one embodiment the method includes: the user processing system obtaining a user command from the user in accordance with user interactions with the graphical user interface; if the aerial vehicle is within communication range of the user processing system, the user processing system transmitting a vehicle command to the aerial vehicle based on the user command; and the aerial vehicle executing the vehicle command.

In one embodiment the method includes: the aerial vehicle transmitting status data to the user processing system, the status data including at least one of: a mission status; and status of one or more subsystems of the aerial vehicle; and the user processing displaying the status data using the graphical user interface.

In one embodiment the method includes: the aerial vehicle transmitting a completion message to the user processing system upon completion of autonomous flight in accordance with the flight instructions data; and the user processing system generating a user notification in response to receiving the completion message.

In one embodiment the user defined flight instructions are for causing the aerial vehicle to: fly autonomously beyond visual line of sight of the user; and fly autonomously outside of communication range of the user processing system.

In one embodiment the range sensor is a Lidar sensor.

In one embodiment the environment is a GPS-denied environment.

In one embodiment the environment is one of indoors and underground.

In one embodiment the method includes using a simultaneous localisation and mapping algorithm to at least one of: generate a map of the environment based on the range data; and generate pose data indicative of a position and orientation of the aerial vehicle relative to the environment.

In one embodiment the user defined flight instructions are for causing the aerial vehicle to fly autonomously into a region of the environment for which map data is not available.

In one embodiment the user defined flight instructions include a user defined exploration target obtained in accordance with user interactions with the graphical user interface.

In one embodiment the user defined exploration target is at least one of a target waypoint; a target plane; a target area; a target volume; a target object; and a target point.

In one embodiment the user defined flight instructions are for causing the aerial vehicle to fly autonomously towards the target plane while performing collision avoidance in accordance with the range data.

In one broad form an aspect of the present invention seeks to provide a method for use in performing exploration and mapping of an environment, the method being performed using an aerial vehicle including a range sensor for generating range data indicative of a range to the environment and a user processing system that wirelessly communicates with the aerial vehicle when the aerial vehicle is within communication range of the user processing system, the method including, in the user processing system: receiving map data based on the range data whilst the aerial vehicle is within communication range of the user processing system; displaying a map representation based on the map data using a graphical user interface; obtaining user defined flight instructions in accordance with user interactions with the graphical user interface; and transmitting flight instructions data to the aerial vehicle based on the user defined flight instructions, whilst the aerial vehicle is within communication range of the user processing system, and wherein the aerial vehicle is responsive to fly autonomously in accordance with the flight instructions data and the range data.

In one broad form an aspect of the present invention seeks to provide a system for use in performing exploration and mapping of an environment, the system including: an aerial vehicle including a range sensor for generating range data indicative of a range to the environment; and a user processing system configured to wirelessly communicate with the aerial vehicle when the aerial vehicle is within communication range of the user processing system, and wherein the user processing system is configured to: receive map data based on the range data whilst the aerial vehicle is within communication range of the user processing system; display a map representation based on the map data using a graphical user interface; obtain user defined flight instructions in accordance with user interactions with the graphical user interface; and transmit flight instructions data to the aerial vehicle based on the user defined flight instructions, whilst the aerial vehicle is within communication range of the user processing system, and wherein the aerial vehicle is responsive to fly autonomously in accordance with the flight instructions data and the range data.

It will be appreciated that the broad forms of the invention and their respective features can be used in conjunction, interchangeably and/or independently, and reference to separate broad forms is not intended to be limiting.

### BRIEF DESCRIPTION OF THE DRAWINGS

Various examples and embodiments of the present invention will now be described with reference to the accompanying drawings, in which:

FIG. 1 is a flowchart of an example of a process of performing exploration and mapping of an environment using an aerial vehicle and a user processing system;

FIG. 2 is an example of an aerial vehicle system including an aerial vehicle and a user processing system that wirelessly communicates with the aerial vehicle when the aerial vehicle is within communication range of the user processing system;

FIG. 3 is a diagram of an example scenario of performing exploration and mapping of an environment using the aerial vehicle and the user processing system of FIG. 2;

FIG. 4 is a schematic diagram of an example of internal components of a mapping and control system of the aerial vehicle of FIG. 2;

FIG. 5 is a schematic diagram of an example of internal components of the user processing system of FIG. 2;

FIG. 6 is a flowchart of an example of a process of the aerial vehicle flying autonomously to perform exploration and mapping of an environment;

FIGS. 7A and 7B are a flowchart of an example of a process for performing mapping and controlling an aerial vehicle using the mapping and control system of FIG. 4;

FIG. 8 is a flowchart of an example of an iterative process of performing exploration and mapping of an environment over multiple autonomous flights of the aerial vehicle;

FIGS. 9A to 9C are screenshots of an example of a graphical user interface in use while performing exploration and mapping of an environment; and

FIG. 10 is a diagram of another example scenario of performing exploration and mapping of an environment using the aerial vehicle and the user processing system of FIG. 2.

### DETAILED DESCRIPTION OF THE PREFERRED EMBODIMENTS

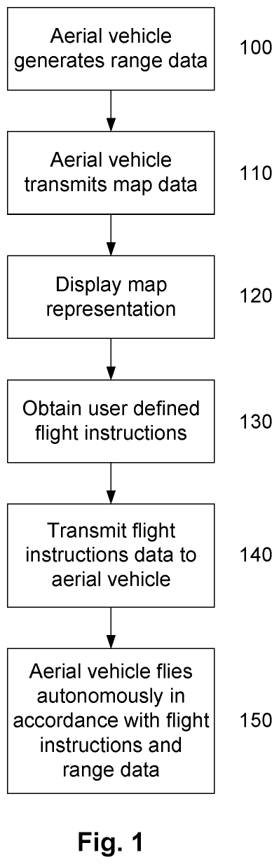

An example of a method for use in performing exploration and mapping of an environment will now be described with reference to FIG. 1.

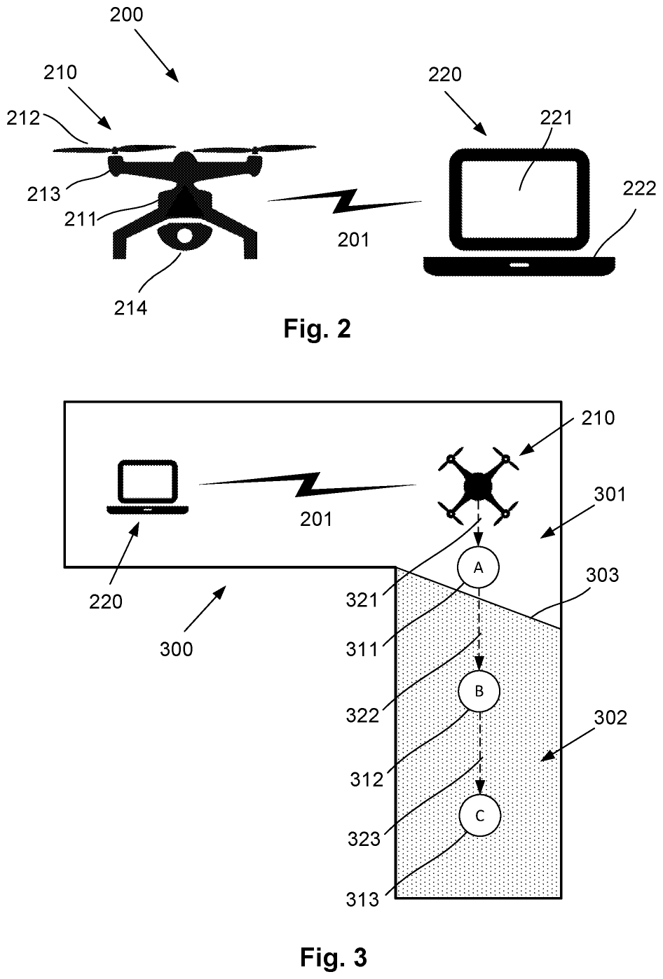

It will be assumed that the method is performed using an aerial vehicle system 200 as shown in FIG. 2. The system 200 broadly includes an aerial vehicle 210 and a user processing system 220 that wirelessly communicates, using a wireless communications link 201, with the aerial vehicle 210 when the aerial vehicle 210 is within communication range of the user processing system 220.

Turning back to the flowchart of FIG. 1, the method involves a sequence of steps performed by the aerial vehicle 210 and the user processing system 220 as discussed below. In this regard, it is noted that the flowchart of FIG. 1 depicts the steps of the method from the perspective of the user processing system 220, for the sake of convenience only.

At step 100, the aerial vehicle 210 generates range data using a range sensor 214 of the aerial vehicle 210. The range data is indicative of a range to the environment. In one example, the range sensor may be provided using a Lidar sensor, although other suitable sensors may be used.

At step 110, whilst the aerial vehicle 210 is within communication range of the user processing system 220, the aerial vehicle 210 transmits, to the user processing system 220, map data based on the range data. It should be appreciated that the map data may be based on range data generated from flight of the aerial vehicle beyond communication range, and the condition that the aerial vehicle 210 is within communication range of the user processing system 220 only applies to the actual transmission of the map data from the aerial vehicle 210 to the user processing system 220.

At step 120, upon receipt of the transmitted map data, the user processing system 220 displays, using a graphical user interface, a map representation based on the map data. As will be described in further detail below, the map data will typically include information regarding the environment surrounding the aerial vehicle 210 in three dimensions, however the map representation displayed in the graphical user interface will typically involve a two dimensional representation of this information to allow it to be displayed on a conventional two dimensional display device of the user processing system 220.

Then, at step 130, the user processing system 220 obtains user defined flight instructions in accordance with user interactions with the graphical user interface. For example, the user may interact with the graphical user interface with regard to the map representation, to define waypoints, flight paths, manoeuvres or the like, as desired to allow exploration and mapping of the environment.

At step 140, whilst the aerial vehicle 210 is within communication range of the user processing system 220, the user processing system 220 transmits, to the aerial vehicle 210, flight instructions data based on the user defined flight instructions. For example, the flight instructions data may include waypoints, flight paths, manoeuvres as per the user defined flight instructions, or other flight instructions derived from the user defined flight instructions. In some examples, the flight instructions data may involve modifications to the user defined flight instructions, for instance to ensure safe flight of the aerial vehicle 210 in accordance with predefined safety parameters. For instance, a user defined waypoint may be shifted to a minimum safe distance from the environment before being included as a waypoint in the user defined flight instructions.

Finally, at step 150, the aerial vehicle 210 flies autonomously in accordance with the flight instructions data and the range data. In one example, this may involve the aerial vehicle determining a flight plan based on the flight instructions data, the aerial vehicle flying autonomously in accordance with the flight plan. During this autonomous flight, the aerial vehicle 210 will typically continue to generate range data using the range sensor 214 and thus continue to build up the range data for previously unknown regions of the environment. The aerial vehicle 210 may simultaneously use the range data to control its autonomous flight. In some examples, these operations may be facilitated using a mapping and control system of the aerial vehicle 210, further details of which will be described in due course.

In view of the above, it will be appreciated that embodiments of the method may include generating a map of the environment based on the range data. Thus, the method may be used to perform exploration and mapping of an environment.

It should be appreciated that the user defined flight instructions may include flight instructions that, if executed by the aerial vehicle 210, will cause the aerial vehicle 210 to fly outside of communication range of the user processing system 220 or outside of the line of sight of a user operating the user processing system 220. In fact, this is an intended and advantageous usage scenario of the method, as this will enable exploration and mapping of a previously unknown environment. In this regard, it should be understood that the range data upon which the map data and subsequent map representation are based may be indicative of the range to features of the environment located beyond communication range of the user processing system 220. This is because the range data is generated by the range sensor of the aerial vehicle 210 and will be indicative of the range to features of the environment relative to the position of the aerial vehicle 210 when it is generated.

In one example, the range data may be indicative of the range to features of the environment in the line of sight of the range sensor 214 of the aerial vehicle 210. Accordingly, it will be appreciated that this can result in map data and a subsequent map representation based the range data which is indicative of any environment that is or was previously in the line of sight of the range sensor 214 during flight of the aerial vehicle 210. Thus, the user will be able to define user defined flight instructions for causing the vehicle 210 to fly into regions of the environment that are or were in the line of sight of the range sensor 214, which may be outside of outside of communication range of the user processing system 220 or outside of the line of sight of a user operating the user processing system 220.

It should also be appreciated that some implementations of the method will be particularly suitable for performing exploration and mapping of unknown GPS-denied environments, such as indoors and underground. This is at least partially enabled by the use of the range data to localise the aerial vehicle 210 in the environment to allow controlled autonomous flight of the aerial vehicle 210 without requiring external localisation information such as a GPS location, and to simultaneously map the environment during the autonomous flight of the aerial vehicle 210 to extend the effective range of operations beyond visual line of sight of the operator or communications range of the user processing system 220.

One especially advantageous area of applicability for this method is the exploration and mapping of areas that are otherwise inaccessible to humans, such as in underground mining stopes, underground urban utility tunnels, collapsed tunnels and indoor structures, or the like. Typically, there will be no pre-existing map information available for these types of environments, and a GPS signal will be unavailable, thus preventing the use of traditional unmanned navigation techniques. However, it will be appreciated that the above described method can allow effective exploration and mapping of these types of environments, by facilitating autonomous flight of the aerial vehicle 210 into unmapped and GPS-denied locations beyond visual line of sight and/or communication range.

An example scenario of performing exploration and mapping of an environment in accordance with the above method will now be described with regard to FIG. 3, which illustrates a simplified two dimensional example of an indoor or underground GPS-denied environment 300.

In this example, the environment consists of a first tunnel and a second tunnel extending from the first tunnel at a corner junction. The user processing system 220 is located in a stationary position at an end of the first tunnel opposing the corner junction. For the purpose of this example, it is assumed that the user processing system 220 is capable of establishing a communication link 201 with the aerial vehicle 210 for enabling wireless communications when the aerial vehicle 210 is within the line of sight of the user processing system 220, as indicated in FIG. 3. Accordingly, an unshaded first region 301 of the environment is considered to be within communication range, whilst a shaded second region 302 of the environment is considered to be outside of communication range, with the first region 301 and second region 302 being separated by a communication range threshold 303 which corresponds to a boundary of the line of sight of the user processing system 220 in relation to the corner junction.

Although the communication range threshold 303 has been considered to correspond to line of sight in this example for the sake of simplicity, it will be understood that this is not necessarily the case in practical implementations. For example, communication range may extend beyond line of sight, particularly in confined spaces where communications signals may be able to ‘bounce’ from surfaces into regions beyond line of sight. Accordingly, it should be understood that references to operations within communication range should not be interpreted as being limited to operations within line of sight only.

For the purpose of this example, it is assumed that the aerial vehicle 210 has already flown to its indicated starting position in the corner junction between the first and second tunnels, such that it is still within the line of sight of the user processing system 220 and thus within communication range of the user processing system 220 as discussed above. It will be appreciated that the aerial vehicle 210 may be deployed to this starting position through manually controlled flight using conventional remote control techniques, but further exploration into the second tunnel using conventional remote control techniques will not be possible as this will take the aerial vehicle 210 outside of communication range. Alternatively, it will be appreciated that the aerial vehicle 210 may have arrived at this starting position through earlier autonomous flight performed in accordance with the method.

In any event, exploration and mapping of the second tunnel in this example scenario may be performed in accordance with the above described method as follows.

First, the aerial vehicle 210 will generate range data relative to its starting position using the range sensor 214. In this case, the range data will be indicative of a range to the environment within the line of sight of the aerial vehicle 210, and accordingly, the generated range data may extend into the second tunnel and thus may be indicative of the range to the environment within the shaded second region 302, which is not within communication range of the user processing system 220 as discussed above.

Whilst the aerial vehicle 210 is still within communication range of the user processing system 220 in its starting position, the aerial vehicle 210 will then transmit, to the user processing system 220, map data based on the range data. It will be appreciated that this map data will include information regarding the environment in the second tunnel and the shaded second region 302 within it.

Next, the user processing system 220 will display, using a graphical user interface presented on its display 221, a map representation based on the map data. In this case, the map representation may include a representation of a map of the environment in the second tunnel, including the shaded second region 302 that is outside of communication range. The user may then interact with the graphical user interface so that the user processing system 220 can obtain user defined flight instructions.

These user defined flight instructions will be defined by the user with regard to the map representation of the environment and relative to previously unknown features of the environment in the second tunnel that have now been revealed using the range data.

In this example scenario, it will be assumed that the user defined flight instructions include a sequence of waypoints through which the user desires the aerial vehicle 210 to fly. In this case, the user defined flight instructions specifically include waypoint “A” 311, waypoint “B” 312, and waypoint “C” 313, such that the aerial vehicle 210 is to fly through the waypoints in that order.

Whilst the aerial vehicle 210 is still within communication range of the user processing system 220, the user processing system 220 will then transmit, to the aerial vehicle 210, flight instructions data based on the user defined flight instructions. In this regard, the user processing system 220 may process the user defined flight instructions to check whether these will allow safe operations of the aerial vehicle 210 or to generate more sophisticated flight instructions with regard to the user defined flight instructions.

For instance, the user processing system 220 will check whether the waypoints 311, 312, 313 are separated from the environment by a predefined safe separation distance, and if this is not the case for any waypoints, they may be shifted to provide the required separation distance. In this case, the user processing system 220 will determine flight path segments 321, 322, 323 between the starting position of the aerial vehicle 210 and the waypoints 311, 312, 313, to thereby define a flight path to be traveled by the aerial vehicle 210 in accordance with the user defined flight instructions. The user processing system 220 may also conduct further checking into whether these flight path segments 321, 322, 323 maintain a safe separation distance between the aerial vehicle 210 and the environment at any position along the flight path.

In any event, once the aerial vehicle 210 has received the flight instructions data from the user processing system 220, the aerial vehicle 210 may then proceed to fly autonomously in accordance with the flight instructions data and the range data. In this example scenario, this will cause the aerial vehicle 210 to autonomously fly to the waypoints 311, 312, 313 in sequence, following the flight path segments 321, 322, 323. Accordingly, the aerial vehicle 210 can autonomously explore the second tunnel including the portion of the environment within the second tunnel that is outside of the line of sight of the user processing system 220 and hence outside of communications range.

During its autonomous flight, the aerial vehicle 210 will continue to generate new range data, and this will also be used in controlling the flight of the aerial vehicle 210. For instance, the range data may be used to localise the aerial vehicle 210 with respect to a map of the environment based on previously generated range data, and may be used in the selection of manoeuvres for executing a flight plan in accordance with the flight instructions data. The range data may further allow for modifications to the flight plan as new information regarding the environment is obtained, or allow collision avoidance to be performed during flight in the event of an obstacle being detected in the flight path using the range data.

Furthermore, the continued collection of range data can be used for mapping the environment and adding to any existing map of the environment that had already been generated. It will be expected that continued exploration and mapping may potentially reveal further new regions of the environment that were previously unknown. For instance, when the aerial vehicle 210 reaches waypoint “C” 313, the new range data generated at that point could potentially indicate that there is a third tunnel branching off from the end of the second tunnel.

It will be appreciated that such a third tunnel (not shown) could be subsequently explored and mapped in a further iteration of the method. To enable this, the aerial vehicle 210 would first return to a position within communication range of the user processing system 220, so that further map data based on the new range data can be transmitted to the user processing system 220. In this regard, the aerial vehicle 210 may be configured to autonomously return to the original starting position upon completion of autonomous flight in accordance with the flight instructions data.

This further map data can be used to update the map representation displayed on the graphical user interface of the user processing system 220, thereby revealing any newly discovered regions of the environment to the user. The user can then define further user defined flight instructions for requesting further exploration of the environment, including into these newly discovered regions. New flight instructions data can then be subsequently transmitted from the user processing system to the aerial vehicle 210 since the aerial vehicle 210 will still be within communication range. In this regard, the aerial vehicle 210 may hover or land at its position while it awaits new flight instructions data.

In some other implementations, the aerial vehicle 210 may be configured to store a position of a last waypoint or position that was within communications range, and autonomously return to that last waypoint or position upon completion of autonomous flight in accordance with the flight instructions data. This may help to avoid unnecessary additional return flight of the aerial vehicle 210 further into communication range than would be required to restore the communication link 201.

For instance, in this example scenario, the aerial vehicle 210 would only need to return to waypoint “A” 311 to restore the communication link 201, rather than returning all the way to the original starting position. The aerial vehicle 210 may be configured to store an indication of communication status at each waypoint during its autonomous flight and use this to autonomously return to the last waypoint encountered that was within communication range. It should also be understood that the return flight does not need to retrace the previous flight path that was followed when the aerial vehicle 210 was flying in accordance with the flight instructions data. Rather, the aerial vehicle 210 may determine a new flight path that most efficiently returns the aerial vehicle 210 to the required position to enable communications, but with regard to the range data and any map information that has already been generated, to ensure safe flight in relation to any obstacles in the environment.

In any case, it will be appreciated that exploration and mapping of complex environments can be performed through an iterative application of the above described method. The aerial vehicle can autonomously fly a series of missions to generate range data that reveals further environmental information, enabling progressively deeper exploration and mapping of the previously unknown regions of the environment. As mentioned above, these operations can be performed without access to a GPS signal and into regions of the environment that are beyond visual line of sight and outside of communication range.

Further details of an example of the aerial vehicle system 200 of FIG. 2 for use in the above discussed method will now be described.

In this case, the aerial vehicle 210 is an unmanned aerial vehicle (UAV), which may also be interchangeably referred to as a drone in the following description. In these examples, the aerial vehicle 210 is provided including a body 211, such as an airframe or similar, having a number of rotors 212 driven by motors 213 attached to the body 211. The aerial vehicle may be provided using a commercially available drone or may be in the form of a specialised custom built aerial vehicle platform.

The aerial vehicle 210 is typically in the form of an aircraft such as a rotary wing aircraft or fixed wing aircraft that is capable of self-powered flight. In this example, the aerial vehicle 210 is a quadrotor helicopter, although it will be appreciated that other aerial vehicles 210 may include single rotor helicopters, dual rotor helicopters, other multirotor helicopters, drones, aeroplanes, lighter than air vehicles, such as airships, or the like.

The aerial vehicle 210 will typically be capable of fully autonomous flight and will typically include one or more on-board processing systems for controlling the autonomous flight and facilitating other functionalities of the aerial vehicle. For example, the aerial vehicle 210 may include a flight computer configured to interface with components of the aerial vehicle 210 such as sensors and actuators and control the flight of the vehicle 210 accordingly. The aerial vehicle 210 may include subsystems dedicated to functionalities such as mapping and control, navigation, and the like. The aerial vehicle 210 will also include a communications interface for allowing wireless communications.

The aerial vehicle 210 will further include one or more sensors for enabling the functionalities of the exploration and mapping method, which are integrated into the aerial vehicle 210. Some or all of the sensors may be provided as part of a separate payload that is attached to the body 211 of the aerial vehicle 210, or otherwise may be directly integrated into the aerial vehicle 210. In some cases, at least some of the sensors may be provided as standard equipment in a commercially available aerial vehicle 210.

In this case the one or more sensors include at least the range sensor 214 described in the method above. As mentioned previously, the range sensor 214 may be a Lidar sensor, although other sensors capable of detecting a range to the environment, such as a stereoscopic imaging system, could be used. In any event, the range sensor 214 will be used to generate range data indicative of a range to the environment, for use in the above described method. It will be appreciated that a variety of other sensors may be integrated to the aerial vehicle 210, such as image sensors (e.g. cameras), thermal sensors, or the like, depending on particular requirements.

In some implementations, the aerial vehicle 210 may include an inbuilt aerial vehicle control system, which may include one or more sensors such as a GPS (Global Positioning System) sensor, orientation sensors, such as an IMU, optical sensors, such as cameras, or the like. Signals from the sensors are typically used by associated processing and control electronics to control the motors 213, and hence control the attitude and thrust of the vehicle. The vehicle control system is typically adapted to operate in accordance with input commands received from a remote control system, or similar, optionally with a degree of autonomy, for example to implement collision avoidance processes, navigate to defined waypoints, or the like. It will be appreciated from this that in one example the aerial vehicle 210 can be a commercially available drone, and as the operation of such drones is well known, features of the aerial vehicle 210 will not be described in further detail.

In some implementations, the aerial vehicle 210 may further include a mapping and control system for facilitating functionalities for mapping an environment and autonomously controlling the flight of the aerial vehicle 210 within the environment in accordance with the map. In some examples, a mapping and control system may be provided separately as part of a payload that is attached to the aerial vehicle 210. The payload may also include the range sensor 214. However, in other examples, the mapping and control system may be more tightly integrated in the aerial vehicle 210 itself.

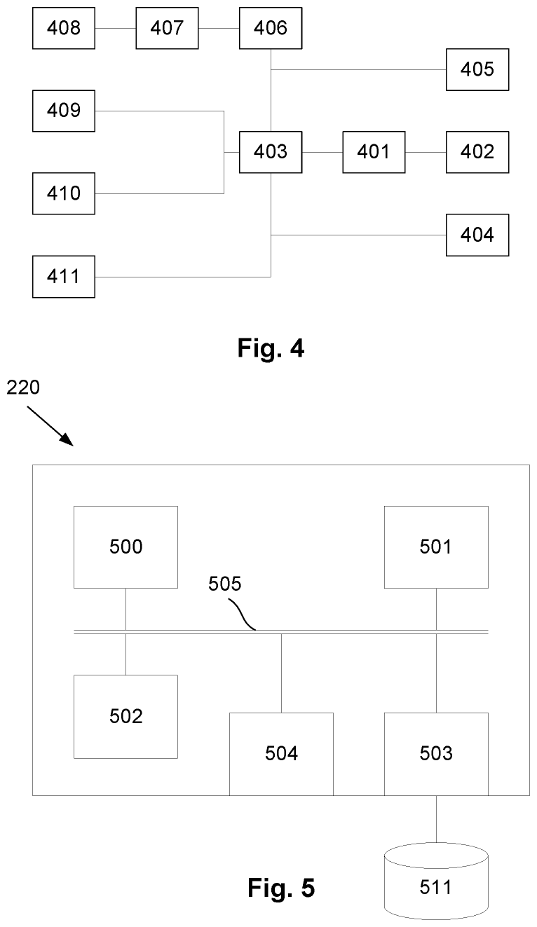

Further details of an example of the internal components of a mapping and control system will now be described with reference to FIG. 4.

In this example, the mapping and control system includes one or more processing devices 401, coupled to one or more communications modules 402, such as a USB or serial communications interface, and optional wireless communications module, such as a Wi-Fi module. The processing device 401 is also connected to a control board 403, which provides onward connectivity to other components, for example generating control signals for controlling operation of the sensors, and at least partially processing sensor signals. For example, the control board 403 can be connected to an input/output device 404, such as buttons and indicators, a touch screen, or the like, and one or more memories 405, such as volatile and/or non-volatile memories. The control board 403 is also typically coupled to a motor 407 for controlling movement of the Lidar sensor 408, to thereby perform scanning over a field of view, and an encoder 406 for encoding signals from the Lidar sensor 408. An IMU 409 is also provided coupled to the control board 403, together with optional cameras and GPS modules 410, 411.

It will be appreciated that the user processing system 220 should be configured to provide a graphical user interface (GUI) for allowing the user interactions involved in the method. Accordingly, the user processing system 220 will typically include a display 221 for presenting the GUI and one or more input devices 222, such as a keypad, a pointing device, a touch screen or the like for obtaining inputs from the user, as the user interacts with the GUI. Whilst a separate input device 222 in the form of a keypad is shown in the example of FIG. 2, it will be appreciated that if a touch screen display 221 is used, the input device 222 will be integrally provided as part of the display 221. In another example, the display could include a virtual reality or augmented reality display device, such as a headset, with integrated or separate input controls, such as a hand held controller, pointer, or gesture based control input.

An example of a suitable user processing system 220 is shown in FIG. 5. In this example, the user processing system 220 includes an electronic processing device, such as at least one microprocessor 500, a memory 501, an input/output device 502, such as a touch screen display or a separate keyboard and display, an external interface 503, and a communications interface 504, interconnected via a bus 505 as shown. In this example the external interface 503 can be utilised for connecting the processing system 220 to peripheral devices, such as communications networks, databases 511, other storage devices, or the like. Although a single external interface 503 is shown, this is for the purpose of example only, and in practice multiple interfaces using various methods (e.g. Ethernet, serial, USB, wireless or the like) may be provided. It will be appreciated that the communications interface 504 of the user processing system 220 should be selected for compatibility with the respective communications interface of the aerial vehicle 210.

In use, the microprocessor 500 executes instructions in the form of applications software stored in the memory 501 to perform required processes, such as wirelessly communicating with the aerial vehicle 210 via the communications interface 504. Thus, actions performed by the user processing system 220 are performed by the processor 500 in accordance with instructions stored as applications software in the memory 501 and/or input commands received via the I/O device 502, or data received from the aerial vehicle 210. The applications software may include one or more software modules, and may be executed in a suitable execution environment, such as an operating system environment, or the like.

Accordingly, it will be appreciated that the user processing system 220 may be formed from any suitable processing system, such as a suitably programmed computer system, PC, web server, network server, or the like, with a suitably configured communications interface 504. In one particular example, the processing system 220 is a standard processing system such as a 32-bit or 64-bit Intel Architecture based processing system, which executes software applications stored on non-volatile (e.g., hard disk) storage, although this is not essential. However, it will also be understood that the processing system 220 could be or could include any electronic processing device such as a microprocessor, microchip processor, logic gate configuration, firmware optionally associated with implementing logic such as an FPGA (Field Programmable Gate Array), or any other electronic device, system or arrangement.

Examples of the above described methods will now be described in further detail. For the purpose of these examples, it is assumed that the process is administered by the user processing system 220, whereby interaction by a user, such as to define user defined flight instructions, is via the graphical user interface of the user processing system 220. The user processing system 220 will wirelessly communicate with the aerial vehicle 210 while the aerial vehicle 210 is within communications range of the user processing system 220 to thereby allow data to be transmitted between the aerial vehicle 210 and the user processing system 220, as required for performing the method. For instance, the aerial vehicle 210 will transmit map data to the user processing system 220 and the user processing system 220 will transmit flight instructions data to the aerial vehicle 210. Such data transmission could be via a direct communications link, or could be via intermediate infrastructure, such as one or more repeaters, such as WiFi repeaters or similar.

However, it will be appreciated that the above described configuration assumed for the purpose of the following examples is not essential, and numerous other configurations may be used. It will also be appreciated that the partitioning of functionality between the aerial vehicle 210 and the user processing system 220 may vary, depending on the particular implementation.

As discussed above, after the user processing system 210 transmits the flight instructions data to the aerial vehicle 220, the aerial vehicle 220 will then fly autonomously in according with the flight instructions and the range data. It should be appreciated that the aerial vehicle 220 may utilise previously generated range data along with any new range data that may be generated during this autonomous flight.

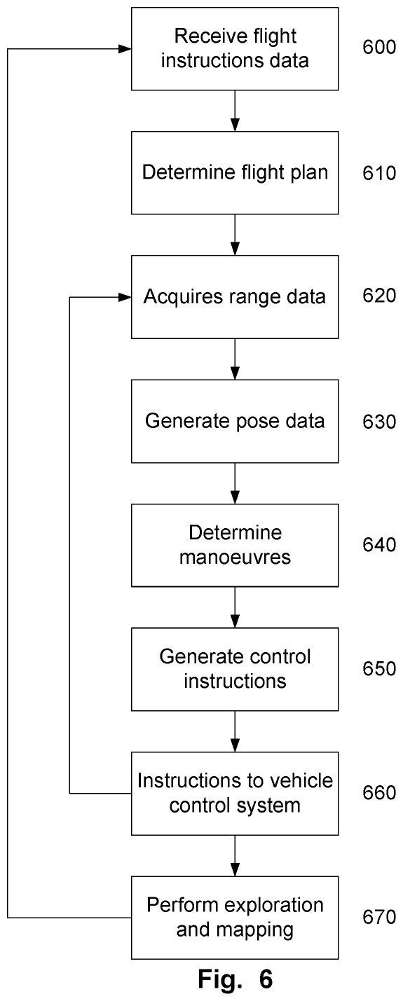

In one example, the mapping and control system described above with regard to FIG. 4 can be used to perform mapping and control of the aerial vehicle 210, to thereby enable the autonomous exploration and mapping of an environment using the aerial vehicle 210, and an example of this will now be described with reference to FIG. 6.

The process of this example commences at step 600, in which the aerial vehicle 210 receives flight instructions data from the user processing system 220. In view of the above it will be appreciated that this step will require that the aerial vehicle 210 is within communication range of the user processing system 220.

Then, at step 610, the mapping and control system of the aerial vehicle 210 may determine a flight plan based on the flight instructions data, and stores flight plan data indicative of the flight plan in the memory 405. For example, the flight plan may be determined with regard to waypoints or flight paths or other types of flight instructions that may be provided in the flight instructions data. In determining the flight plan, the mapping and control system may also utilise the range data or information derived from the range data, such as a map of the environment that may be generated based on the range data during flight.

At step 620, during flight the mapping control system acquires range data generated by the range sensor 214, which is indicative of a range to an environment. It will be appreciated that the format of the range data will depend on the nature of the range sensor 214, and some processing may be required in order to ensure the range data is in a format suitable for downstream processing, for example to convert stereoscopic images to depth information.

At step 630, the processing device 401 generates pose data indicative of a position and orientation of the aerial vehicle 210 relative to the environment, using the range data. It will be appreciated that pose data can be generated from the range data utilising a simultaneous localisation and mapping (SLAM) algorithm or any other suitable approach and as such techniques are known, these will not be described in any further detail. In one particular example, this involves generating a low resolution map, which can be used for mapping purposes, although this is not necessarily essential.

Having determined pose data, at step 640, the processing device 401 then uses this, together with flight plan data, to identify manoeuvres that can be used to execute the flight plan. For example, the flight plan may require that the aerial vehicle 210 fly to a defined location in the environment, and then map an object. In this instance, the current pose is used to localise the aerial vehicle 210 within the environment, and thereby ascertain in which direction the aerial vehicle 210 needs to fly in order to reach the defined location. The processing device 401 interprets this as one or more manoeuvres, for example including a change in attitude and/or altitude of the aerial vehicle 210, and then flying at a predetermined velocity for a set amount of time. Further manoeuvres to achieve the flight plan can then be identified in a similar manner.

At step 650 the processing device 401 generates control instructions based on the manoeuvres, with the control instructions being transferred to a vehicle control system of the aerial vehicle 210 (such as an on-board flight computer) at step 660 in order to cause the aerial vehicle 210 to implement the manoeuvres. The nature of the control instructions may vary depending on the preferred implementation and the capabilities of the vehicle control system. For example the vehicle control system may require instructions in the form of an indication of a desired vehicle thrust and attitude. Alternatively however the vehicle control system may include a degree of built-in autonomy in which case the instructions could direct the vehicle control system to fly in a defined direction at a defined speed.

The above steps 620 to 660 are repeated, allowing the aerial vehicle 210 to be controlled in order to execute a desired mission. In this example, the mission of the aerial vehicle 210 is exploring an environment and collecting range data for use in generating a map of the environment as indicated in step 670. Once a particular desired mission has been executed in accordance with received flight instructions data from step 600, the aerial vehicle 210 may be configured to await further flight instructions data for a new desired mission, in which case the entire process may be repeated once again starting at step 600.

Mapping can be performed utilising a SLAM algorithm and it will therefore be appreciated from this that the range data acquired at step 620 from the range sensor can be utilised to perform both control of the aerial vehicle 210 and mapping of the environment. Indeed, the step of generating the pose data at step 630 could involve the use of a SLAM algorithm, in which case mapping could be performed concurrently as part of the control process. However, this is not necessarily essential and in alternative examples, a low resolution SLAM process may be performed in order to generate the pose data for control purposes, with the range data being stored and used to perform a higher resolution SLAM process in order to perform mapping of the environment at a subsequent stage, for example after a flight has been completed.

In any event, it will be appreciated that the above described mapping and control system can be integrated with the aerial vehicle 210 and used to control the aerial vehicle 210 in flight while simultaneously provide mapping functionality. This allows an existing aerial vehicle 210 with little or no autonomy and/or no mapping capabilities, to be easily adapted for use in autonomous exploration and mapping applications as described above.

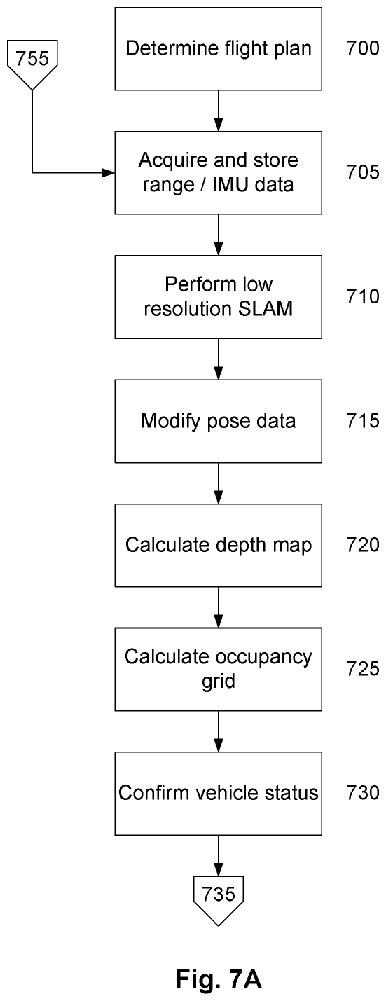

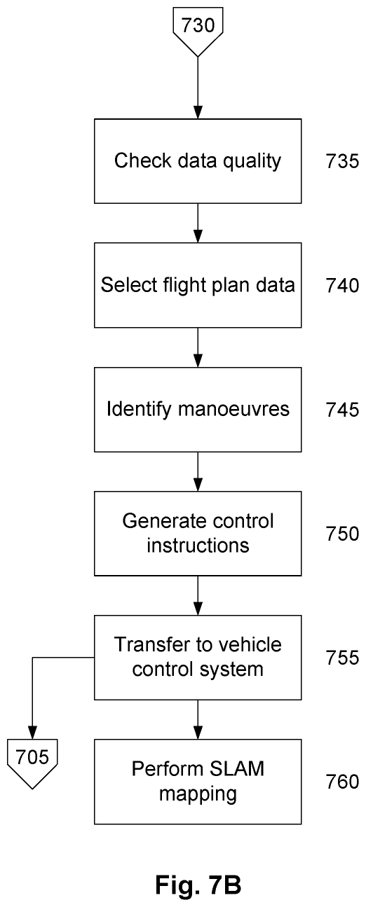

A more specific example of a control mapping process will now be described with reference to FIGS. 7A and 7B.

In this example, at step 700, a flight plan is determined, typically based on the received flight instructions data as discussed above. The flight plan may be generated and stored in the control and mapping system memory 405.

At step 705, range and movement and orientation data are obtained from the Lidar and IMU 408, 409, with these typically being stored in the memory 405, to allow subsequent mapping operations to be performed. The range data is used by the processing device 401 to implement a low resolution SLAM algorithm at step 710, which can be used to output a low resolution point cloud and pose data. The pose data can be modified at step 715, by fusing this with movement and/or orientation data from the IMU to ensure robustness of the measured pose.

At step 720, the processing device 401 calculates a depth map, which involves determining a minimum range to the environment for directions surrounding the vehicle. In this regard, the range data will be parsed to identify a minimum range in a plurality of directions around the vehicle. At step 725, the processing device 401 calculates an occupancy grid including an occupancy in voxels for a three dimensional grid around the vehicle. This is typically achieved by segmenting the point cloud and examining for the presence of points within the different voxels of a three dimensional grid surrounding the vehicle. This is used to identify obstacles around the vehicle, allowing paths along which the vehicle can fly to be identified.

At step 730 the processing device 401 confirms a vehicle status by querying the vehicle control system, and examining the pose data to ensure previous control instructions have been implemented as expected. At step 735, the quality of the collected data is examined, for example by ensuring the range data extends over a region to be mapped, and to ensure there is sufficient correspondence between the movements derived from pose data and measured by the IMU.

At step 740, a flight path data is selected taking into account the depth map, the occupancy grid, the vehicle status, the data quality, and the current flight plan. For example, by default a primary flight plan would be selected in order to achieve the current flight plan. However, this may be modified taking into account the vehicle status, so, for example, if the processing device 401 determines the vehicle battery has fallen below a threshold charge level, the primary flight plan could be canceled, and a return to home flight plan implemented, to return the vehicle to a defined home location before the battery runs out. Similarly, if it is identified that the data being collected is not of a suitable quality for downstream mapping, this can be used to allow a previous part of the mission to be repeated in order to collect additional data.

In another example, the processing device 401 periodically updates the return to home flight plan, determines an estimate of energy required to implement the return to home flight plan, and determines if the vehicle battery (or other energy source depending on the vehicle configuration) has sufficient energy required to implement the return to home flight plan. If the difference between the vehicle battery and the energy required is below a predetermined threshold, the processing device 401 implements the return to home flight plan and returns the vehicle to the defined home location. In this example, the return to home flight plan takes ‘worst case scenario’ into consideration. The ‘worst case scenario’ may be the safest flight path home or the longest flight path to home.

The processing device 401 identifies one or more manoeuvres at step 745 based on the selected flight plan and taking into account the occupancy grid, the configuration data and depth map. Thus, the processing device 401 can determine one or more locations to which the vehicle should travel, plotting a path to the locations based on the occupancy grid and the flight capabilities of the vehicle, using this to determine the manoeuvres required to fly the path. Having determined the manoeuvres, the processing device 401 generates control instructions at step 750, taking into account the calibration data so that instructions are translated into the coordinate frame of the vehicle.

The control instructions are transferred to the vehicle control system at step 755 causing these to be executed so that the vehicle executes the relevant manoeuvre, with the process returning to step 705 to acquire further range and IMU data following the execution of the control instructions.

At the end of this process, the range data can be analysed using a high resolution SLAM algorithm in order to generate a map at step 760. Whilst this can be performed on-board by the processing device 401 in real-time, more typically this is performed after the flight is completed, allowing this to be performed by a remote computer system. This allows a low resolution SLAM process to be used for flight control purposes, enabling more robust approaches to be used in real time, whilst reducing the computational burden on the mapping and control system, reducing hardware and battery requirements, and thereby enabling a lighter weight arrangement to be used. This also reduces latency, making the approach more responsive than would otherwise by the case.

Further optional and/or preferred features of the method will now be described.

As mentioned above, the method may involve generating a map of the environment based on the range data. It should be appreciated that such a map of the environment may be generated by the aerial vehicle 210, by the user processing system 220, or both. In some examples, each of the aerial vehicle 210 and the user processing system 220 may maintain separate respective maps of the environment. These respective maps may be generated in different ways using different sets of data, depending on requirements. For instance a map of the environment may be generated by the aerial vehicle 210 for use during autonomous flight, and due to processing limitations the fidelity of this map may be reduced such that it only uses a subset of the generated range data. On the other hand, the user processing system 220 may generate its own map of the environment based on the complete set of range data, although this may be limited in turn by data transmission bandwidth.

In one example, a high fidelity map of the environment may be generated as a post-processing activity based on a complete set of the range data that is stored in a memory of the aerial vehicle 210 but not transmitted to the user processing system 220. In this example, the stored range data may be downloaded to another processing system for generating the map of the environment. Otherwise, the aerial vehicle 210 and the user processing system 220 may utilise lower fidelity maps for the purpose of performing the method.

In some implementations, the method includes one or more vehicle processing devices of the aerial vehicle 210 determining a flight plan based on the flight instructions data, so that the aerial vehicle 210 flies autonomously in accordance with the flight plan. It will be appreciated that this may involve known unmanned aerial vehicle navigation techniques for determining a suitable flight plan based on received flight instructions data such as waypoints, flight paths, or the like, which will not be discussed at length herein.

As discussed above, the range data is used in the autonomous flight of the aerial vehicle 210 in addition to its use in providing map data to the user processing system 220, and examples of how the range data may be used will now be outlined.

In some examples of the method, the one or more vehicle processing devices may use the range data to generate pose data indicative of a position and orientation of the aerial vehicle 210 relative to the environment. This pose data may then be used together with the flight instructions data to identify manoeuvres that can be used to execute the flight plan. Then, the one or more vehicle processing devices may generate control instructions in accordance with the manoeuvres and transfer the control instructions to a vehicle control system of the aerial vehicle to cause the aerial vehicle to implement the manoeuvres and thereby fly autonomously in accordance with the flight plan. Further detailed examples of these types of vehicle control functionalities will be described in due course.

Some implementations of the method may involve using the range data and pose data to generate a depth map indicative of a minimum range to the environment in a plurality of directions, and identifying the manoeuvres in accordance with the depth map to thereby perform collision avoidance. Additionally or alternatively, some implementations of the method may involve using the range data and pose data to generate an occupancy grid indicative of the presence of the environment in different voxels of the grid and identifying the manoeuvres using the occupancy grid.

While the aerial vehicle 210 is flying autonomously, the aerial vehicle 210 may perform collision avoidance in accordance with the range data and at least one of an extent to the aerial vehicle and an exclusion volume surrounding an extent of the aerial vehicle. This can help to ensure that a minimum safe separation distance is maintained during flight, even if obstacles are encountered that were not expected when the user defined flight instructions were being defined.

As far as the user defined flight instructions are concerned, in some implementations these may include one or more user defined waypoints as mentioned above. These user defined waypoints will typically be obtained in accordance with user interactions with the graphical user interface. Accordingly, the method may further include the user processing system 220 generating the flight instructions data based on the one or more user defined waypoints and the map data.

In some examples, the method may include the user processing system 220 determining whether each user defined waypoint is separated from the environment by a predefined separation distance. It will be appreciated that this will effectively provide a check into whether the aerial vehicle 210 will be safely separate from the environment as it passes through each waypoint.

In some implementations of the method, in the event of a determination that the user defined waypoint is separated from the environment by the predefined separation distance, the user processing system 220 may simply generate the flight instructions data using the user defined waypoint. On the other hand, in the event of a determination that the user defined waypoint is not separated from the environment by the predefined separation distance, the user processing system 220 may modify the user defined waypoint before generating the flight instructions data using the resulting modified user defined waypoint. For example, the user processing system 220 may modify the user defined waypoint by shifting the user defined waypoint to a nearby point that is separated from the environment by the predefined separation distance.

However, it should be appreciated that in some other implementations, the user processing system 220 may generate a completely different set of waypoints based on the user defined waypoints, or the user processing system 220 may otherwise generate flight instructions data that does not utilise waypoints at all, but instead provides flight instructions of a different type, depending on the configuration of the aerial vehicle 210.

In other examples, the user defined flight instructions may include a predefined flight path segment selected in accordance with user interactions with the graphical user interface. For instance, the graphical user interface may allow the user to define flight path segments based on predefined templates corresponding to standard types of flight paths, such as a straight line, an arc, or the like.

In some examples, this may be expanded to include more sophisticated predefined flight path templates for exploring and mapping particular types of environmental features that may be present in the environment. For example, a predefined flight path template may be selected for causing the aerial vehicle 210 to automatically perform sweeps across a surface such as a wall to allow range data to be captured for mapping fine details of the wall. The user interactions for selecting such a predefined flight path could include selecting an environmental feature in the map representation and establishing boundaries for allowing a suitable flight path to be generated with regard to the boundaries and other parameters of the environmental feature.

In another example, the method may include a cylindrical flight path template which may allow the aerial vehicle to automatically fly along a helical route along a cylindrical surface, to thereby allow the orderly mapping of a wall of an underground mining stope or any other environmental feature defining a generally cylindrical volume.

In some cases, the user defined flight instructions may include a predefined flight plan selected in accordance with user interactions with the graphical user interface. In one example, the user may be able to select a “return home” flight plan which will simply cause the aerial vehicle 210 to fly autonomously to the user processing system or some other designated home position. It will be appreciated that other more sophisticated predefined flight plans may be made available, which may depend on the particular application of the method and other requirements.

In some examples, the method may include having the user processing system 220 generate a preview flight path based on the user defined flight instructions and the map data, and then displaying, using the graphical user interface, the preview flight path in the map representation, for approval by the user. However, it should be noted that the preview flight path will not necessarily reflect the actual flight path that will ultimately be taken by the aerial vehicle 210. This is because the aerial vehicle 210 will typically determine its flight plan using its own on-board processing systems which may utilise different algorithms or different information regarding the environment, which could result in a different flight path. Nevertheless, this can provide useful visual feedback of the likely path of the autonomous flight of the aerial vehicle 210, to thereby allow the user to consider whether this will be suitable for the intended mission objectives.

In some particular implementations, the user processing system 220 may generate the preview flight path by determining flight path segments between waypoints of the user defined flight instructions, in a similar manner as shown in FIG. 3. In some examples, this may further include having the user processing system 220 determine each flight path segment so that the flight path segment is separated from the environment by a predefined separation distance. It will be appreciated that this may involve accepting or modifying the flight path segment depending on whether the predefined separation is achieved, as per the above described technique of checking user defined waypoints against the predefined separation distance.

In some examples, the user processing system 220 will be configured to obtain user approval of the preview flight path in accordance with user interactions with the graphical user interface and only transmit the flight instructions data to the aerial vehicle 210 in response to this user approval.

If the user does not approve of the preview flight path, this may be because the user wishes to make modifications to the user defined flight instructions and hence cause the generation of a new preview flight path. To facilitate this, the user processing system 220 may be configured to obtain a user modification input in accordance with user interactions with the graphical user interface, for identifying a desired modification to the user defined flight instructions. Then, the user processing system 220 may modify the user defined flight instructions in response to the user modification input.

In one example of the types of user modifications that might be requested, the user defined flight instructions may include waypoints and the user defined flight instructions may be modified by removing one of the waypoints, moving one of the waypoints, or adding a new waypoint. However, other types of potential modifications will be readily apparent in the context of the described method.

As discussed above, the generation of range data may be a continuous process which allows the progressive exploration and mapping of complex environments. Typically, whilst the aerial vehicle 210 is flying autonomously, the aerial vehicle will continue to generate range data. Thus, in some examples, whilst the aerial vehicle 210 is within communication range of the user processing system 220, the aerial vehicle 210 may transmit to the user processing system 220, further map data generated based on the range data.

It will be appreciated this further map data may also be transmitted when the aerial vehicle 210 returns into communication range after a period of flying autonomously outside of communication range. In such cases, the further map data may be stored until such time as a communication link 201 is re-established and transmission of the further map data can resume. In some examples, this transmission of further map data may occur in discrete downloads, which may optionally only be performed in response to user interactions with the graphical user interface. Alternatively, the further map data may be continuously transmitted whenever the aerial vehicle 210 is within communication range.

In some examples, the further map data that is transmitted may be restricted in view of wireless communication bandwidth limitations or other constraints. For instance, the aerial vehicle 210 may transmit further map data that includes any updates to the map data, or may selectively limit the further map data to only include updates to the map data in a predetermined time window, updates to the map data within a predetermined range of the aerial vehicle, or updates to the map data within a predetermined range of waypoints. It will be appreciated that different conditions may be imposed on the extent of further map data that is transmitted depending on the particular application of the method and other operational requirements.

As also mentioned above, implementations of the method may involve having the aircraft return to a communications position that is in communication range of the user processing system 220 upon completion of autonomous flight in accordance with the flight instructions data, to transmit any further map data and await any further flight instructions that may be transmitted in response to further user defined flight instructions via the graphical user interface, particularly with regard to the further map data.

In some examples, the method may include the aerial vehicle 210, upon completion of autonomous flight in accordance with the flight instructions data, initially determining whether the aerial vehicle 210 is currently within communication range of the user processing system 220, at its final position. In the event of a determination that the aerial vehicle 210 is already within communication range, the aerial vehicle 210 may be configured to hover at the final position to await transmission of further flight instructions data from the user processing system 220. On the other hand, in the event of a determination that the aerial vehicle 210 is not currently within communication range, the aerial vehicle 210 may be configured to autonomously fly to a communications position that is within communication range and hover at that communications position to await transmission of further flight instructions data from the user processing system 220.

The communications position could be a previous position where communications were known to be able to occur, or alternatively could be a position determined dynamically. For example, communication signal parameters, such as a signal strength or bandwidth could be monitored, with the communications position being determined when certain criteria, such as a signal strength threshold and bandwidth threshold, are met. For example, it might be more efficient to travel a further 10 m to a location where bandwidth is increased in order to reduce a communication time. The communications position can be determined by monitoring communication parameters in real time, for example by having the vehicle return along an outward flight path until the criteria are met, or could be determined in advance, for example by monitoring communication parameters on an outward flight path, and storing an indication of one or more communications positions where communication parameters meet the criteria.

It will be appreciated that the communications positions could be selected taking into account other factors, such as an available flight time, or battery power. Thus, in one example, an optimisation process is used to balance an available flight time versus the need to communicate. For example, flying further might allow a communications duration to be reduced, which in turn could extend the overall flight time available. Implementations of this functionality of autonomously returning into communication range may include having one or more vehicle processing devices of the aerial vehicle 210 determine a return flight plan based on the communications position and the range data. This will generally be performed in a similar manner as discussed above for determining a flight plan in accordance with the flight instructions data. The aerial vehicle 210 may then fly autonomously to the communications position (within communication range of the user processing system 220) in accordance with the return flight plan.

It will be appreciated that the return flight plan may involve a more direct flight path than may have been followed by the aerial vehicle 210 in arriving in its final position upon completion of the autonomous flight. However, determining the return flight plan will require the use of the range data to ensure that a safe flight path is followed with regard to the surrounding environment. Typically, this will involve the use of known navigation functionality with regard to a map of the environment that has been generated by the aerial vehicle during its earlier autonomous flight.

In some particular implementations, whilst the aerial vehicle 210 is flying autonomously, the one or more vehicle processing devices may determine whether the aerial vehicle 210 is within communication range of the user processing system, and store at least an indication of a communications position that was/is within communication range. In some examples, this may involve the aerial vehicle 210 repeatedly checking its communication link with the user processing system 220, and in the event of a loss of communication, storing an indication of communications positions in which the communication link is still active. In examples where the flight instructions data includes waypoints, this may involve the aerial vehicle 210 storing an indication of whether each waypoint is within communication range after flying autonomously through each waypoint.

As far as the map data is concerned, this may take a range of different forms depending on the particular implementation and requirements such as bandwidth limitations. In different examples, the map data may include at least some of the range data, a three dimensional map generated based on the range data, an occupancy grid indicative of the presence of the environment in different voxels of the grid, a depth map indicative of a minimum range to the environment in a plurality of directions, or a point cloud indicative of points in the environment detected by the range sensor.

Furthermore, in the interest of preserving communications bandwidth, processing resources and/or memory consumption, the map data may be at least one of generated as a down-sampled version of a map generated by the aerial vehicle using the range data, generated using simplified representations of known types of structures determined using the range data, or generated based on a subset of the range data.

Turning to the map representation that is based on the map data, this may also take a range of different forms depending on requirements. Typically, the map representation will include a two dimensional representation of the environment generated using the map data, which will usually be based on three dimensional range data. It will be appreciated that one challenge in displaying the map representation to the user will be to reliably convey three dimensional information in a two dimensional format. In one example, colour coded points may be used in the map representation, where a colour of each point may be selected to indicate a position of the point in at least one dimension or a distance of the point relative to the aerial vehicle in at least one dimension. In this way, the user may gain further insight into environmental features indicated in the map representation. In any event, a range of different techniques may be available with regard to known three dimensional techniques for representing three dimensional information on two dimensional displays.

As mentioned above, some implementations may involve generating map data using simplified representations of known types of structures determined using the range data. The map representation may utilise these simplified representations, from the map data, or alternatively, the user processing system 220 may determine its own simplified representations of known types of structures using the map data. For instance, environmental features corresponding to regular structural features such as walls, floors, ceiling and the like may be represented by simplified geometrical representations of these features.

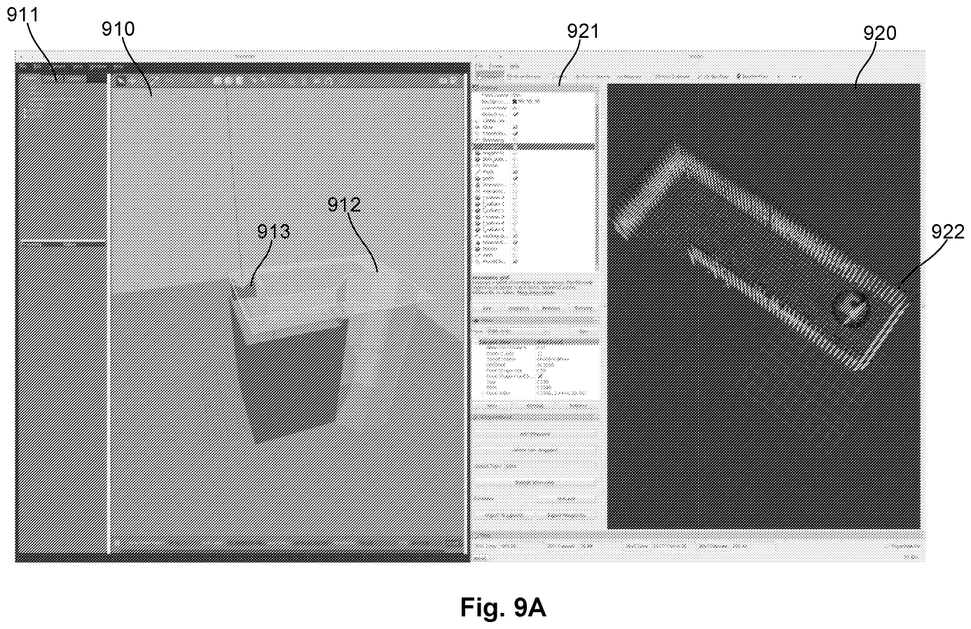

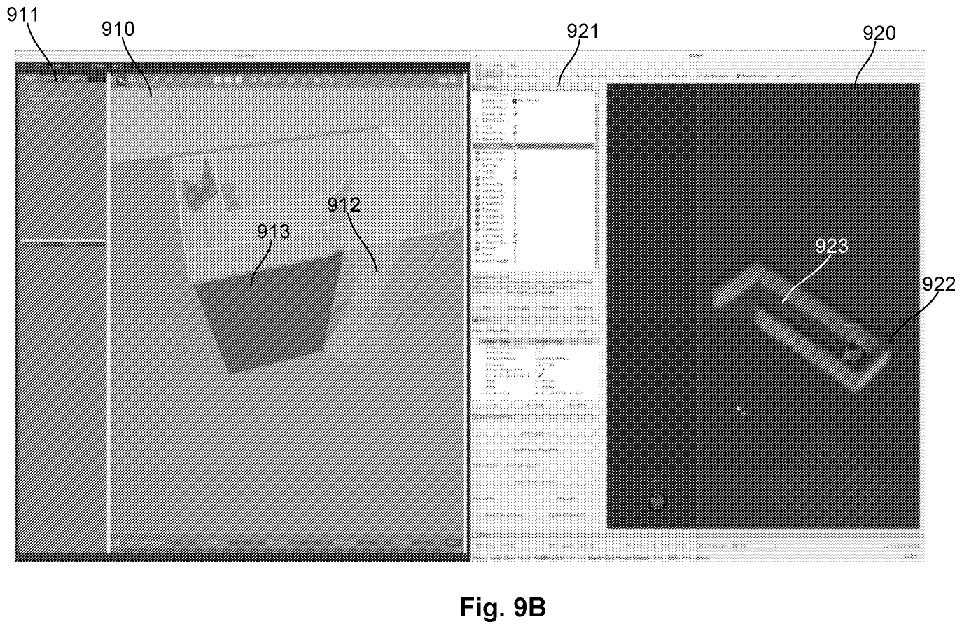

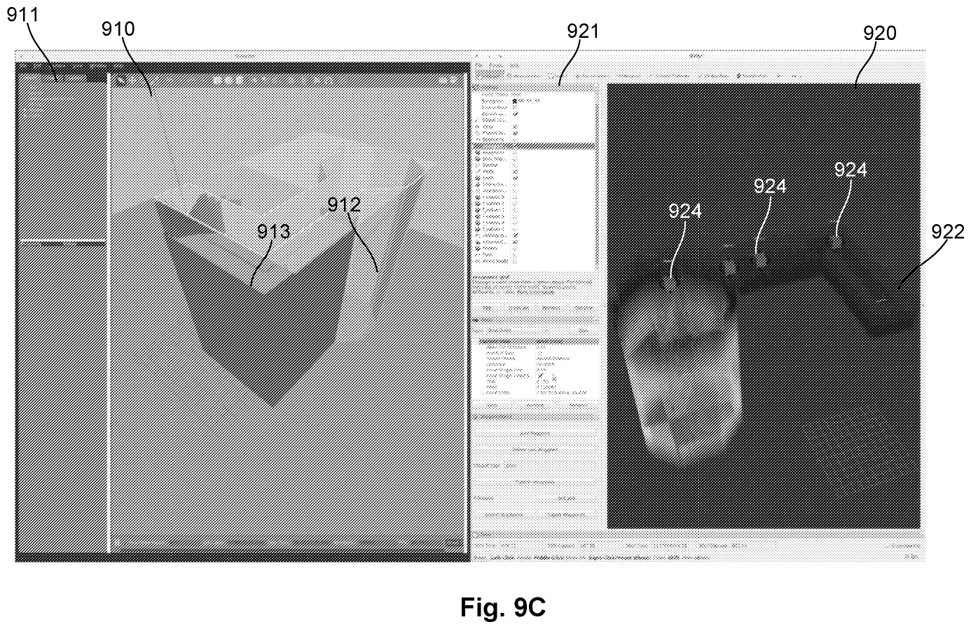

In some examples, the graphical user interface may display more than one map representation simultaneously. For instance, in the example graphical user interface screenshots shown in FIGS. 9A to 9C, a first map representation is displayed based on a map of the environment including simplified representations of known types of structures as discussed above, and a second map representation is displayed based on a colour coded point cloud that more closely represents the range data that has been generated by the aerial vehicle 210. The example graphical user interface shown in FIGS. 9A to 9C will be described in more detail in due course.

It should also be appreciated that the graphical user interface may be capable of dynamically updating the map representation in response to user manipulations of the map representation, in accordance with user interactions with the graphical user interface. For instance, the user may be able to manipulate the view of the map representation using known techniques, such as by zooming, panning, tilting or rotating the map representation. Furthermore, the user may be able to switch between different map representation modes or perform more advanced manipulations such as taking cross section views of the map representation, for instance.

The graphical user interface may also allow other relevant information to be presented to the user. For example, the aerial vehicle 210 may transmit, to the user processing system, pose data together with the map data, and the user processing system 220 may in turn display a vehicle representation in the map representation based on the pose data.

In another example, the aerial vehicle 210 may transmit, to the user processing system 220, flight plan data indicative of a flight plan determined by the aerial vehicle 210, and the user processing system 220 may display a representation of the flight plan in the map representation, based on the flight plan data. As mentioned above, the flight plan determined by the aerial vehicle 210 may differ from the preview flight path generated by the user processing system 220, and this feature may allow a final check of the flight plan of the aerial vehicle 210 to be performed by the user before it commences autonomous flight, which may take the aerial vehicle 210 outside of communication range such that further control inputs by the user will not be possible.

It should be appreciated that the map representation may be updated in real-time as map data and potentially other data is received from the aerial vehicle 210 during its autonomous flight. Thus, the user processing system 220 can effectively provide a live representation of the exploration and mapping results to the user as it is being performed.

Furthermore, in some implementations, the graphical user interface may be configured to allow the user to define more sophisticated flight behaviours than the waypoints and flight paths mentioned above. These may be used to give the user finer control over the autonomous flight of the aerial vehicle, depending on the desired exploration and mapping objectives.

For example, the user processing system 220 may obtain at least one user selected heading in accordance with user interactions with the graphical user interface, with the user processing system 220 generating the flight instructions data in accordance with the user selected heading. It will be appreciated that this may allow the user to specify which direction the aerial vehicle 210 is pointing during the autonomous flight, for instance to ensure that the range sensor 214 is focused towards a particular region of interest during flight to ensure higher quality mapping of that region. In the absence of such heading information, the aerial vehicle might simply assume a default heading which focuses the range sensor 214 in its direction of travel for collision avoidance.

However, it will be appreciated that embodiments of the aerial vehicle 210 may include a scanning range sensor 214 which provides broad coverage around the aerial vehicle 210, such that user control of the heading of the aerial vehicle 210 may be of lesser importance in these cases.

In some examples, the user processing system 220 may determine flight parameters with regard to the user defined flight instructions, and generate the flight instructions data in accordance with the flight parameters. This may allow the user to take control of particular flight parameters such as the flight speed of the aerial vehicle, maximum acceleration rates, or the like.

In some implementations, the user processing system 220 may be configured to obtain a user command from the user in accordance with user interactions with the graphical user interface, such that, if the aerial vehicle 210 is within communication range of the user processing system 220, the user processing system 220 may transmit a vehicle command to the aerial vehicle 210 based on the user command, which will then be executed by the aerial vehicle 210.

For instance, the user may be able to input a user command for commanding the aerial vehicle 210 to immediately abort any current autonomous flight and return home. In another example, the user may input a user command for commanding the aerial vehicle 210 to pause its autonomous flight and hover in its current position until commanded to resume its flight. While the aerial vehicle 210 is paused, the user may modify the user defined flight instructions and transmit new flight instructions data, such as to cause further detailed mapping of a newly revealed feature during autonomous flight.

However, it will be appreciated that this will only be possible while the aerial vehicle 210 is within communication range of the user processing system 220. In some examples, if a user command is obtained while the aerial vehicle 210 is outside of communication range, the transmission of the vehicle command may be deferred until such time as the aerial vehicle 210 returns to a position within communication range and the communication link is re-established.

Implementations of the method may also allow the aerial vehicle 210 to transmit status data to the user processing system 220 for display to the user via the graphical user interface. The status data may include, for example, a mission status or a status of one or more subsystems of the aerial vehicle.

It may also be desirable to provide a capability for the aerial vehicle 210 to transmit a completion message to the user processing system 220 upon completion of autonomous flight in accordance with the flight instructions data, where the user processing system will generate a corresponding user notification in response to receiving the completion message. This will once again be dependent on the aerial vehicle 210 being within communication range at the time. However, in view of the above it will be appreciated that the aerial vehicle 210 may be configured to autonomously return to a communications position that was determined to be within communication range upon completion of its autonomous flight, and thus the completion message can be transmitted once the aerial vehicle 210 has returned within communication range.

In view of the above, it will be appreciated that implementations of the method can be used to allow to performance of exploration and mapping operations in which the aerial vehicle 210 can fly autonomously beyond visual line of sight of the user and/or outside of communication range of the user processing system. Implementations of the method can also allow exploration and mapping operations to be performed in GPS-denied environments, such as indoors and underground.

In view of the above, it will also be appreciated that multiple autonomous flights may be performed in an iterative manner to progressively explore and map these types of environments, which would otherwise be difficult or impossible to explore and map using conventional unmanned aerial vehicle control techniques.

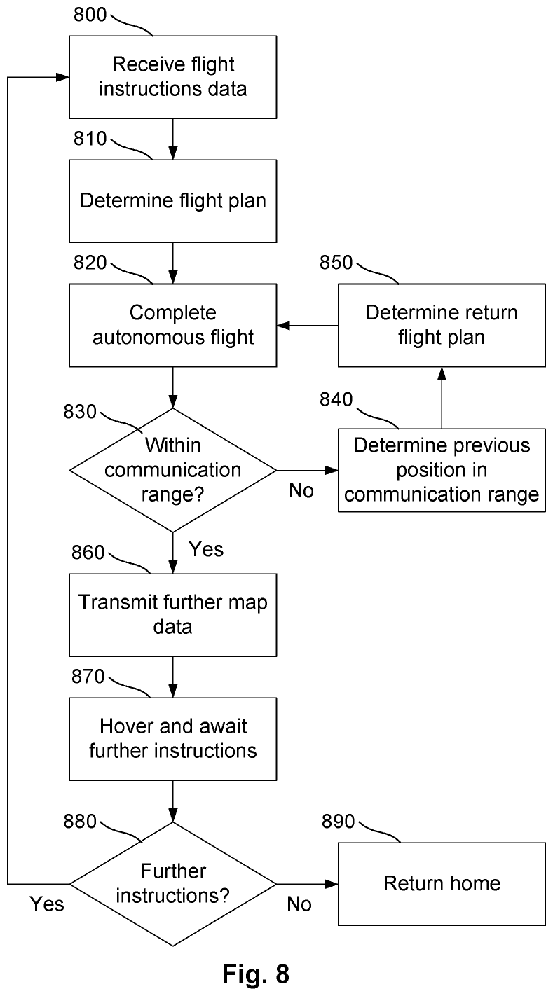

An example of such an iterative procedure for performing multiple autonomous flights in this manner will now be described with regard to FIG. 8. It should be noted that this process is illustrated from the perspective of the aerial vehicle 210, under the assumption that the functionalities of the user processing system 220 will be performed in accordance with the above description.

At step 800, the aerial vehicle 210 receives a first set of flight instructions data from the user processing system, which as discussed above are based on the user defined flight instructions obtained from the user via the graphical user interface. At step 810, the aerial vehicle 210 determines a corresponding first flight plan, and at step 820 the aerial vehicle 210 completes its flight autonomously using the flight plan.

The final position of the aerial vehicle 210 at this stage will depend on the flight instructions data, and may or may not be within communications range. Accordingly, at step 830, the aerial vehicle 210 will check whether it is within communications range. If not, at step 840 the aerial vehicle 210 will determine a communications position that was within communications range, such as by accessing a stored indication of the most recent waypoint, or another intermediate position, that was determined to be within communication range during prior autonomous flight. At step 850 the aerial vehicle 210 will then determine a return flight plan for efficiently returning to communications range, with regard to the range data and any map of the environment that has been generated during prior autonomous flight. When the aerial vehicle has completed the autonomous return flight at step 820, the aerial vehicle 210 will once again check whether it is within communications range at step 830. It will be appreciated that as an alternative, the system could simply monitor communications parameters in real time, and then return along the outward path, or along another path to previous waypoints, until a communications position with required communications parameters is reached.

In the event the aerial vehicle 210 is confirmed to be in communication range as a result of the check performed at step 830 (whether at the end of its autonomous flight in accordance with the initial flight plan or the return flight plan), at step 860 the aerial vehicle 210 will transmit further map data to the user processing system 220. As discussed above, this further map data can be used to extend the map representation displayed to the user on the graphical user interface of the user processing system 220 to allow further user defined flight instructions to be obtained for causing exploration and mapping of previously unknown regions of the environment.

At step 870, after transmission of the map data, the aerial vehicle 210 will hover and await the transmission of further instructions from the user processing system 220. If further instructions are provided, these will typically be in the form of further flight instructions data, which when received will effectively cause the process to be repeated from step 800. On the other hand, if no further instructions are provided, at step 890 the aerial vehicle 210 may return home. In one example, this may be in response to a “return home” command input by the user via the graphical user interface, or otherwise this may be a default action of the aerial vehicle under certain circumstances, such as in the event of low battery, or if a predefined time period elapses without any further instructions being received.

It will be appreciated that this iterative process can be repeated as required to complete desired exploration and mapping objectives for a particular environment.

Features of an example of a graphical user interface for use in some implementations of the above described method will now be described with regard to FIGS. 9A to 9C.

In this regard, the user interface includes a first window 910, which shows a schematic representation 912 of the environment including simplified representations of known types of structures. This is typically generated based on basic information, and could be based on a visual survey of the environment, and/or models used in creating the environment. For example, when creating a stope, a section of material is removed, often using explosives. Prior to this commencing, modeling is performed to predict the shape of the resulting stope, so this can be used to generate the schematic representation shown in the first window 910. The model may be retrieved from modeling software and/or created or modified using tools displayed in a toolbar 911.

A second window 920 is provided displaying a colour coded point cloud 922 that more closely represents the range data that has been generated by the aerial vehicle 210. The second window includes a toolbar 921, which shows display options that can be used to control the information presented in the second window, for example to control the density and colour of points that are displayed. The toolbar 921, also allows the user to display and add waypoints and paths.

As mapping progresses, the windows are updated as shown in FIGS. 9B and 9C, to show additional information, including expansion of the point cloud 922, together with the path 923 traversed by the vehicle and user defined waypoints 924 used to guide navigation of the vehicle.

Thus, it will be appreciated that as the point cloud is progressively generated, the user can define further waypoints and/or paths, allowing mapping of the stope to be extended progressively until the entire stope is mapped.

It will be appreciated that the above described techniques provide a method and algorithms for drone-based exploration and mapping of unknown (i.e. no a priori map) GPS-denied indoor and underground environments, beyond visual line of sight, and beyond communication link range.

In order to better illustrate more specific advantages, further details of a specific embodiment of the method will now be described.

In this embodiment, the method consists of guiding or operating the drone by setting 3D points in real-time on the GUI using a live map transmitted by the drone during flight.

After take-off, the operator may select one or a set of 3D “soft” waypoints on the GUI using the 3D map accumulated so far by the drone. A collision checker algorithm checks whether the waypoints are within a safety distance from obstacles and adjusts any waypoints that do not satisfy this condition by moving them to within a predefined diameter of the obstacles. Such movement can be unconstrained, or could be constrained, for example limiting vertical movement of the waypoints, to maintain waypoints at a fixed height within a tunnel.

The GUI will then run a flight path planning algorithm to show to the operator the path that will be followed by the drone. In some implementations, the same path planning algorithm will be run on the drone in parallel, and in others, an output of the path planning results may be sent to the drone. It is noted that the drone will typically also have its own path planning capability, but if the GUI is using a subsampled map it might give different results.

If desired, the operator can cancel the waypoints and generate new ones. Otherwise, if the operator approves of the flight path, the operator may validate the current waypoints and upload them to the drone for execution.

The drone will then fly the mission autonomously (waypoint navigation) using on-board path planning to reach the waypoints while avoiding obstacles. During the mission, the drone will capture new map information to thereby extend the 3D map. Upon completion, the drone will hover at the last waypoint and wait for new waypoints or other commands.

Based on the new extended 3D map, the operator can select a new set of waypoints that can take the drone beyond visual line of sight and potentially beyond communication link range.

If the communication link is lost during the sub-mission execution, the drone will continue to fly to all waypoints and then come back to the previous hovering waypoint that had a valid communication link, or some other communications point within communication range (communication link boundary). When returning to the communications link boundary the drone does not need to return using the outbound path—it will plan the most efficient return route to the communication link boundary. When in communication range, the drone downloads its updated map to the operator and waits for new waypoints or user commands.

This procedure can be repeated several times with the drone exploring a little further each time, allowing semi-autonomous exploration and mapping of challenging environments beyond visual line of sight and beyond communication range.

It will be appreciated that implementations of this method enable convenient incremental waypoint navigation using incremental map updates. This is facilitated by having the drone return to the last waypoint with communication link at the end of each sub-mission to download the 3D map and to receive the new waypoints or a next sub-mission.

Accordingly, implementations of this method as described above will allow semi-autonomous exploration and mapping of unknown GPS-denied environments beyond visual line of sight and beyond communication range. This can be used effectively in different environments (outdoor, indoor, and underground) and for different applications (inspection, mapping, search and rescue, etc.). The method beneficially allows the operator to plan the bulk of the mission during flight (i.e., selecting desired locations to send the drone). It also allows the exploration and mapping of complex environments in one flight without the need for landing and off-line planning of the next mission.

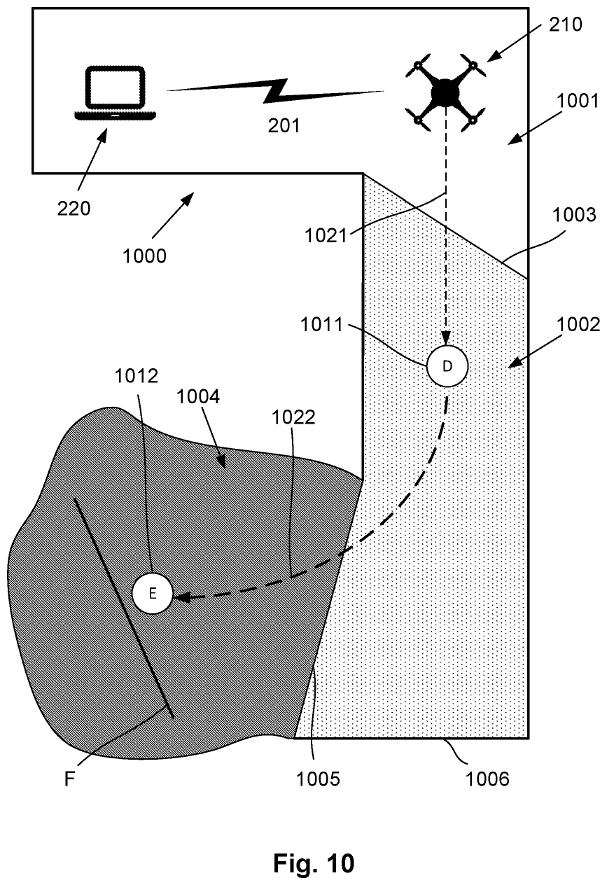

A further example scenario of performing guided exploration and mapping of an environment in accordance with the above method will now be described with regard to FIG. 10, which illustrates a simplified two dimensional example of an indoor or underground GPS-denied environment 1000.

In this example, the environment consists of a first tunnel, a second tunnel extending from the first tunnel at a corner junction, and an unknown region (for which map data is not available). The user processing system 220 is located in a stationary position at an end of the first tunnel opposing the corner junction. For the purpose of this example, it is assumed that the user processing system 220 is capable of establishing a communication link 201 with the aerial vehicle 210 for enabling wireless communications when the aerial vehicle 210 is within communication range of the user processing system 220, as indicated in FIG. 10. Accordingly, an unshaded first region 1001 of the environment is considered to be within communication range, whilst a shaded second region 1002 of the environment is considered to be outside of communication range, with the first region 1001 and second region 1002 being separated by a communication range threshold 1003 which corresponds to a boundary of the communication range of the user processing system 220 in relation to the corner junction.

For the purpose of this example, it is assumed that the aerial vehicle 210 has already flown to its indicated starting position in the corner junction between the first tunnel 1001 and the second tunnel 1002, such that it is still within the line of sight of the user processing system 220 and thus within communication range of the user processing system 220 as discussed above. It will be appreciated that the aerial vehicle 210 may be deployed to this starting position through manually controlled flight using conventional remote control techniques, but further exploration into the second tunnel using conventional remote control techniques will not be possible as this will take the aerial vehicle 210 outside of communication range. Alternatively, it will be appreciated that the aerial vehicle 210 may have arrived at this starting position through earlier autonomous flight performed in accordance with the method.

In any event, guided exploration and mapping of the second tunnel and the unknown extension in this example scenario may be performed in accordance with the above described method as follows.

First, the aerial vehicle 210 will generate range data relative to its starting position using the range sensor 214. In this case, the range data will be indicative of a range to the environment within the line of sight of the aerial vehicle 210, and accordingly, the generated range data may extend into the second tunnel and thus may be indicative of the range to the environment within the shaded second region 1002, which is not within communication range of the user processing system 220 as discussed above.

Whilst the aerial vehicle 210 is still within communication range of the user processing system 220 in its starting position, the aerial vehicle 210 will then transmit, to the user processing system 220, map data based on the range data. It will be appreciated that this map data will include information regarding the environment in the second tunnel and the shaded second region 1002 within it. A shaded third region 1004 of the environment is considered to be the unknown region, with the second region 1002 and unknown region 1004 being separated by a range threshold 1005 which corresponds to a boundary of the line of sight of the aerial vehicle 210.

Next, the user processing system 220 will display, using a graphical user interface presented on its display 221, a map representation based on the map data. In this case, the map representation may include a representation of a map of the environment in the second tunnel, including the shaded second region 1002 that is outside of communication range. The user may then interact with the graphical user interface so that the user processing system 220 can obtain user defined flight instructions.

These user defined flight instructions will be defined by the user with regard to the map representation of the environment and relative to previously unknown features of the environment in the second tunnel that have now been revealed using the range data.

In this example scenario, it will be assumed that the user defined flight instructions may include a sequence of waypoints through which the user desires the aerial vehicle 210 to fly. In this case, the user defined flight instructions specifically include waypoint “D” 1011, such that the aerial vehicle 210 is to fly through the waypoint.

Whilst the aerial vehicle 210 is still within communication range of the user processing system 220, the user processing system 220 will then transmit, to the aerial vehicle 210, flight instructions data based on the user defined flight instructions. In this regard, the user processing system 220 may process the user defined flight instructions to check whether these will allow safe operations of the aerial vehicle 210 or to generate more sophisticated flight instructions with regard to the user defined flight instructions.

In any event, once the aerial vehicle 210 has received the flight instructions data from the user processing system 220, the aerial vehicle 210 may then proceed to fly autonomously in accordance with the flight instructions data and the range data. In this example scenario, this will cause the aerial vehicle 210 to autonomously fly to the waypoint 1011 following the flight path segment 1021. Accordingly, the aerial vehicle 210 can autonomously explore the second tunnel of the environment. During its autonomous flight, the aerial vehicle 210 will continue to generate new range data, and this will also be used in controlling the flight of the aerial vehicle 210.

In this example scenario, the range data indicates that the second region 1002 has an end boundary 1006, which may be used to modify the flight plan to generate an updated user defined flight plan. For example, the updated user defined flight plan may include waypoint “E” 1012, such that the aerial vehicle 210 is to fly toward the waypoint.

It should be appreciated that the user defined flight instructions may include a user defined exploration target, which may, for example, be in the form of target waypoint “E” defined in the unknown region as shown in this example. Accordingly, this exploration target will cause the aerial vehicle 210 to autonomously fly toward the waypoint 1012 following the flight path segment 1022.

Alternatively, the user defined exploration target may be in the form of a target plane “F” as shown in FIG. 10, or in other forms such as a target area (not shown), a target volume (not shown); a target object (not shown) and/or a target point (not shown). When the user defined exploration target is the target plane “F”, the aerial vehicle 210 may fly autonomously toward the nearest point on the plane, i.e. to minimise the separation between the vehicle and the plane. The relative location and orientation of the target plane “F” may be defined by the user to promote autonomous exploration in desired regions of the environment, for instance into a suspected tunnel within an unmapped region of the environment.

It will be appreciated that an exploration target may be used to cause the aerial vehicle 210 to fly autonomously into a region of the environment for which map data is not available. The aerial vehicle 210 may continue its autonomous flight towards the exploration target, obtaining new range data along the way to allow exploration and mapping of the previously unknown region, until a predetermined condition is satisfying for ending the exploration.

For instance, the aerial vehicle 210 may achieve a success condition when the vehicle either reaches the exploration target or comes within a predetermined range of the exploration target. On the other hand, other conditions may cause the aerial vehicle 210 to end the exploration before such a success condition is achieved. For example, the aerial vehicle 210 may be configured to end exploration after a predetermined duration of time or predetermined flight distance, or other conditions may be established for causing the aerial vehicle 210 end the exploration. For instance, it should be appreciated that the vehicle battery may be continuously monitored, and a return to home flight plan as described previously can be implemented, so that the aerial vehicle 210 returns home before consuming more of its available energy reserves than required for the return flight.

In one example, the exploration target may be considered to be achieved if the aerial vehicle 210 comes within a predetermined range of the exploration target. For instance, a target waypoint 1012 may be achieved when the aerial vehicle 210 is within a one meter range of the waypoint 1012. Similarly, a success condition may be considered to be achieved for a target plane “F” if the aerial vehicle 210 comes within one meter of any part of the plane. In some examples, the success condition may also depend on whether or not the aerial vehicle 210 has a clear line of sight to the exploration target.

If an obstacle or restriction is detected on the flight path 1022, the aerial vehicle 210 may return to its initial position within communications range for updates in further flight instructions from the user. However, in some examples, if a success condition cannot be achieved using a first flight path, the aerial vehicle 210 may be configured to retrace the first flight path and attempt to reach the exploration target using a second, different flight path. For example, the aerial vehicle 210 may attempt to reach the exploration target by autonomously flying down branches/tunnels identified using the range data during flight on the first flight path, if the first flight path does not allow the vehicle to come within the predetermined range of the exploration target.

In view of the above, it will be appreciated that the aerial vehicle 210 can autonomously explore the second tunnel of the environment in accordance with the user defined exploration targets. During its autonomous flight, the aerial vehicle 210 will continue to generate new range data, and this will also be used in controlling the flight of the aerial vehicle 210. For instance, it will be appreciate that while the aerial vehicle 210 is flying autonomously towards the exploration target, it will be continuously performing collision avoidance in accordance with the range data.

The new range data may be transmitted to the user processing system 220 when the aerial vehicle returns within communications range, so that further map data may be generated. This further map data can be used to update the map representation displayed on the graphical user interface of the user processing system 220, thereby revealing any newly discovered regions of the environment to the user. The user can then define further user defined flight instructions such as waypoints or exploration targets for requesting further exploration of the environment, including into these newly discovered regions.

In any case, it will be appreciated that exploration and mapping of complex environments can be performed through an iterative application of the above described method. The aerial vehicle can autonomously fly a series of missions to generate range data that reveals further environmental information, enabling progressively deeper exploration and mapping of the previously unknown regions of the environment. As mentioned above, these operations can be performed without access to a GPS signal and into regions of the environment that are beyond visual line of sight and outside of communication range.

Throughout this specification and claims which follow, unless the context requires otherwise, the word “comprise”, and variations such as “comprises” or “comprising”, will be understood to imply the inclusion of a stated integer or group of integers or steps but not the exclusion of any other integer or group of integers. As used herein and unless otherwise stated, the term “approximately” means ±20%.

It must be noted that, as used in the specification and the appended claims, the singular forms “a,” “an,” and “the” include plural referents unless the context clearly dictates otherwise. Thus, for example, reference to “a support” includes a plurality of supports. In this specification and in the claims that follow, reference will be made to a number of terms that shall be defined to have the following meanings unless a contrary intention is apparent.

It will of course be realised that whilst the above has been given by way of an illustrative example of this invention, all such and other modifications and variations hereto, as would be apparent to persons skilled in the art, are deemed to fall within the broad scope and ambit of this invention as is herein set forth.

1. A method for use in performing exploration and mapping of an environment, the method being performed using an aerial vehicle and a user processing system that wirelessly communicates with the aerial vehicle when the aerial vehicle is within communication range of the user processing system, the method including:
a) the aerial vehicle generating range data using a range sensor, the range data being indicative of a range to the environment;
b) whilst the aerial vehicle is within communication range of the user processing system, the aerial vehicle transmitting, to the user processing system, map data based on the range data;
c) the user processing system displaying, using a graphical user interface, a map representation based on the map data;
d) the user processing system obtaining user defined flight instructions in accordance with user interactions with the graphical user interface;
e) whilst the aerial vehicle is within communication range of the user processing system, the user processing system transmitting, to the aerial vehicle, flight instructions data based on the user defined flight instructions; and
f) the aerial vehicle flying autonomously in accordance with the flight instructions data and the range data.

2. The method according to claim 1, wherein the method includes generating a map of the environment based on the range data.

3. The method according to claim 1, wherein the method includes, in one or more vehicle processing devices of the aerial vehicle, determining a flight plan based on the flight instructions data, the aerial vehicle flying autonomously in accordance with the flight plan.

4. The method according to claim 3, wherein the method includes, in the one or more vehicle processing devices:
a) using the range data to generate pose data indicative of a position and orientation of the aerial vehicle relative to the environment;
b) using the pose data and the flight instructions data to identify manoeuvres that can be used to execute the flight plan;
c) generating control instructions in accordance with the manoeuvres; and
d) transferring the control instructions to a vehicle control system of the aerial vehicle to cause the aerial vehicle to implement the manoeuvres and thereby fly autonomously in accordance with the flight plan.

5. The system according to claim 4, wherein the method includes, in the one or more vehicle processing devices:
a) using the range data and pose data to generate a depth map indicative of a minimum range to the environment in a plurality of directions; and
b) identifying the manoeuvres in accordance with the depth map to thereby perform collision avoidance.

6. The method according to claim 4, wherein the method includes, in the one or more vehicle processing devices:
a) using the range data and pose data to generate an occupancy grid indicative of a presence of the environment in different voxels of the occupancy grid; and
b) identifying the manoeuvres using the occupancy grid.

7. The method according to claim 1, wherein the method includes, while the aerial vehicle is flying autonomously, the aerial vehicle performing collision avoidance in accordance with the range data and at least one of:
a) an extent to the aerial vehicle; and
b) an exclusion volume surrounding an extent of the aerial vehicle.

8. The method according to claim 1, wherein the user defined flight instructions include one or more user defined waypoints obtained in accordance with user interactions with the graphical user interface.

9. The method according to claim 8, wherein the method includes the user processing system generating the flight instructions data based on the one or more user defined waypoints and the map data.

10. The method according to claim 9, wherein the method includes, for each user defined waypoint, the user processing system determining whether the user defined waypoint is separated from the environment by a predefined separation distance.

11. The method according to claim 10, wherein the method includes, in the event of a determination that the user defined waypoint is separated from the environment by the predefined separation distance, the user processing system generating the flight instructions data using the user defined waypoint.

12. The method according to claim 10, wherein the method includes, in the event of a determination that the user defined waypoint is not separated from the environment by the predefined separation distance, the user processing system modifying the user defined waypoint and generating the flight instructions data using the resulting modified user defined waypoint.

13. The method according to claim 12, wherein the method includes the user processing system modifying the user defined waypoint by shifting the user defined waypoint to a nearby point that is separated from the environment at least one of:
a) by a predefined separation distance; and
b) in accordance with defined constraints.

14. The method according to claim 1, wherein the user defined flight instructions include a predefined flight path segment selected in accordance with user interactions with the graphical user interface.

15. The method according to claim 1, wherein the user defined flight instructions include a predefined flight plan selected in accordance with user interactions with the graphical user interface.

16. The method according to claim 1, wherein the method includes the user processing system:
a) generating a preview flight path based on the user defined flight instructions and the map data; and
b) displaying, using the graphical user interface, the preview flight path in the map representation, for approval by the user.

17. The method according to claim 16, wherein the method includes the user processing system generating the preview flight path by determining flight path segments between waypoints of the user defined flight instructions.

18. The method according to claim 17, wherein the method includes the user processing system determining each flight path segment so that the flight path segment is separated from the environment by a predefined separation distance.

19. The method according to claim 16, wherein the method includes the user processing system:
a) obtaining user approval of the preview flight path in accordance with user interactions with the graphical user interface; and
b) in response to the user approval, transmitting the flight instructions data to the aerial vehicle.

20. The method according to claim 16, wherein the method includes the user processing system:
a) obtaining a user modification input in accordance with user interactions with the graphical user interface, for identifying a desired modification to the user defined flight instructions; and
b) modifying the user defined flight instructions in response to the user modification input.

21. The method according to claim 20, wherein the user defined flight instructions include waypoints and the method includes modifying the user defined flight instructions by at least one of:
a) removing one of the waypoints;
b) moving one of the waypoints; and
c) adding a new waypoint.

22. The method according to claim 1, wherein the method includes, whilst the aerial vehicle is flying autonomously:
a) the aerial vehicle continuing to generate range data; and
b) whilst the aerial vehicle is within communication range of the user processing system, the aerial vehicle transmitting, to the user processing system, further map data generated based on the range data.

23. The method according to claim 22, wherein the further map data includes one of:
a) any updates to the map data;
b) updates to the map data in a predetermined time window;
c) updates to the map data within a predetermined range of the aerial vehicle; and
d) updates to the map data within a predetermined range of waypoints.

24. The method according to claim 1, wherein the method includes the aerial vehicle, upon completion of autonomous flight in accordance with the flight instructions data, determining whether the aerial vehicle is within communication range of the user processing system at a final position.

25. The method according to claim 24, wherein the method includes, in the event of a determination that the aerial vehicle is within communication range, the aerial vehicle hovering at the final position to await transmission of further flight instructions data from the user processing system.

26. The method according to claim 24, wherein the method includes, in the event of a determination that the aerial vehicle is not within communication range, the aerial vehicle autonomously flying to a communications position that is within communication range and hovering at the communications position to await transmission of further flight instructions data from the user processing system.

27. The method according to claim 26, wherein the method includes, in one or more vehicle processing devices of the aerial vehicle, determining a return flight plan based on the communications position and the range data, the aerial vehicle flying autonomously to the communications position in accordance with the return flight plan.

28. The method according to claim 27, wherein the method includes, whilst the aerial vehicle is flying autonomously, in the one or more vehicle processing devices:
a) determining whether the aerial vehicle is within communication range of the user processing system; and
b) storing at least an indication of a previous location that was within communication range.

29. The method according to claim 28, wherein the flight instructions data includes waypoints and the method includes the aerial vehicle storing an indication of whether each waypoint is within communication range after flying autonomously through each waypoint.

30. The method according to claim 1, wherein the map data includes at least one of:
a) at least some of the range data;
b) a three dimensional map generated based on the range data;
c) an occupancy grid indicative of a presence of the environment in different voxels of the occupancy grid;
d) a depth map indicative of a minimum range to the environment in a plurality of directions; and
e) a point cloud indicative of points in the environment detected by the range sensor.

31. The method according to claim 1, wherein the map data is at least one of:
a) generated as a down-sampled version of a map generated by the aerial vehicle using the range data;
b) generated using simplified representations of known types of structures determined using the range data; and
c) generated based on a subset of the range data.

32. The method according to claim 1, wherein the map representation includes at least one of:
a) a two dimensional representation of the environment generated using the map data; and
b) colour coded points where a colour of each point is selected to indicate at least one of:
i) a position of the point in at least one dimension; and
ii) a distance of the point relative to the aerial vehicle in at least one dimension.

33. The method according to claim 1, wherein the method includes the user processing system dynamically updating the map representation in response to user manipulations of the map representation in accordance with user interactions with the graphical user interface.

34. The method according to claim 1, wherein the method includes:
a) the aerial vehicle transmitting, to the user processing system, pose data together with the map data; and
b) the user processing system displaying a vehicle representation in the map representation based on the pose data.

35. The method according to claim 1, wherein the method includes:
a) the aerial vehicle transmitting, to the user processing system, flight plan data indicative of a flight plan determined by the aerial vehicle; and
b) the user processing system displaying a representation of the flight plan in the map representation, based on the flight plan data.

36. The method according to claim 1, wherein the method includes:
a) the user processing system obtaining at least one user selected heading in accordance with user interactions with the graphical user interface; and
b) the user processing system generating the flight instructions data in accordance with the user selected heading.

37. The method according to claim 1, wherein the method includes:
a) the user processing system determining flight parameters with regard to the user defined flight instructions; and
b) the user processing system generating the flight instructions data in accordance with the flight parameters.

38. The method according to claim 1, wherein the method includes:
a) the user processing system obtaining a user command from the user in accordance with user interactions with the graphical user interface;
b) if the aerial vehicle is within communication range of the user processing system, the user processing system transmitting a vehicle command to the aerial vehicle based on the user command; and
c) the aerial vehicle executing the vehicle command.

39. The method according to claim 1, wherein the method includes:
a) the aerial vehicle transmitting status data to the user processing system, the status data including at least one of:
i) a mission status; and
ii) status of one or more subsystems of the aerial vehicle; and
b) the user processing displaying the status data using the graphical user interface.

40. The method according to claim 1, wherein the method includes:
a) the aerial vehicle transmitting a completion message to the user processing system upon completion of autonomous flight in accordance with the flight instructions data; and
b) the user processing system generating a user notification in response to receiving the completion message.

41. The method according to claim 1, wherein the user defined flight instructions are for causing the aerial vehicle to:
a) fly autonomously beyond visual line of sight of the user; and
b) fly autonomously outside of communication range of the user processing system.

42. The method according to claim 1, wherein the range sensor is a Lidar sensor.

43. The method according to claim 1, wherein the environment is a GPS-denied environment.

44. The method according to claim 1, wherein the environment is one of indoors and underground.

45. The method according to claim 1, wherein the method includes using a simultaneous localisation and mapping algorithm to at least one of:
a) generate a map of the environment based on the range data; and
b) generate pose data indicative of a position and orientation of the aerial vehicle relative to the environment.

46. The method according to claim 1, wherein the user defined flight instructions are for causing the aerial vehicle to fly autonomously into a region of the environment for which map data is not available.

47. The method according to claim 46, wherein the user defined flight instructions include a user defined exploration target obtained in accordance with user interactions with the graphical user interface.

48. The method according to claim 47, wherein the user defined exploration target is at least one of:
a) a target waypoint;
b) a target plane;
c) a target area;
d) a target volume;
e) a target object; and
f) a target point.

49. The method according to claim 47, wherein the user defined flight instructions are for causing the aerial vehicle to fly autonomously towards the user defined exploration target while performing collision avoidance in accordance with the range data.

50. A method for use in performing exploration and mapping of an environment, the method being performed using an aerial vehicle including a range sensor for generating range data indicative of a range to the environment and a user processing system that wirelessly communicates with the aerial vehicle when the aerial vehicle is within communication range of the user processing system, the method including, in the user processing system:
a) receiving map data based on the range data whilst the aerial vehicle is within communication range of the user processing system;
b) displaying a map representation based on the map data using a graphical user interface;
c) obtaining user defined flight instructions in accordance with user interactions with the graphical user interface; and
d) transmitting flight instructions data to the aerial vehicle based on the user defined flight instructions, whilst the aerial vehicle is within communication range of the user processing system, and wherein the aerial vehicle is responsive to fly autonomously in accordance with the flight instructions data and the range data.

51. A system for use in performing exploration and mapping of an environment, the system including:
a) an aerial vehicle including a range sensor for generating range data indicative of a range to the environment; and
b) a user processing system configured to wirelessly communicate with the aerial vehicle when the aerial vehicle is within communication range of the user processing system, and wherein the user processing system is configured to:
i) receive map data based on the range data whilst the aerial vehicle is within communication range of the user processing system;
ii) display a map representation based on the map data using a graphical user interface;
iii) obtain user defined flight instructions in accordance with user interactions with the graphical user interface; and
iv) transmit flight instructions data to the aerial vehicle based on the user defined flight instructions, whilst the aerial vehicle is within communication range of the user processing system, and wherein the aerial vehicle is responsive to fly autonomously in accordance with the flight instructions data and the range data.
